(19) United States
(12) Patent Application Publication
(10) Pub. No.: US 2024/0155647 A1
(43) Pub. Date: May 9, 2024

(54) ELECTRONIC DEVICE, WIRELESS COMMUNICATION METHOD, AND COMPUTER-READABLE STORAGE MEDIUM

(71) Applicant: Sony Group Corporation, Tokyo (JP)

(72) Inventors: Tingting FAN, Beijing (CN); Chen SUN, Beijing (CN)

(73) Assignee: Sony Group Corporation, Tokyo (JP)

(21) Appl. No.: 18/549,355

(22) PCT Filed: Mar. 25, 2022
(86) PCT No.: PCT/CN2022/082910

§ 371 Date: Sep. 7, 2023

(30) Foreign Application Priority Data
Apr. 2, 2021 (CN) 202110361347.9

(51) Int. Cl. H04W 72/232; H04W 72/0446; H04W 72/0453; H04W 72/12

(52) U.S. Cl. CPC H04W 72/232; H04W 72/0446; H04W 72/0453; H04W 72/12

(57) ABSTRACT

The present disclosure relates to an electronic device, a wireless communication method, and a computer-readable storage medium. The electronic device in the present disclosure comprises: a processing circuit, which is configured to: generate first downlink control information (DCI), wherein the first DCI comprises scheduling information of a plurality of data channels; and carries multiple pieces of first DCI by using the data channels. By means of using the electronic device, the wireless communication method and the computer-readable storage medium of the present disclosure, when DCI schedules a plurality of data channels, the probability of a UE correctly decoding the DCI can be improved, that is, the reliability of DCI transmission can be improved.

The present application claims priority to Chinese Patent Application No. 202110361347.9, titled “ELECTRONIC DEVICE, WIRELESS COMMUNICATION METHOD, AND COMPUTER READABLE STORAGE MEDIUM”, filed on Apr. 2, 2021 with the China National Intellectual Property Administration, which is incorporated herein by reference in its entirety.

### FIELD

Embodiments of the present disclosure generally relate to the field of wireless communications, and in particular to an electronic device, a wireless communication method, and a computer readable storage medium. More particularly, the present disclosure relates to an electronic device as a network side device in a wireless communication system, an electronic device as user equipment in a wireless communication system, a wireless communication method performed by a network side device in a wireless communication system, a wireless communication method performed by user equipment in a wireless communication system, and a computer readable storage medium.

### BACKGROUND

Downlink control information (DCI) is sent by a network side device to user equipment (UE). DCI includes but is not limited to resource allocation, HARQ information, power control, and the like. The DCI can schedule a physical downlink share channel (PDSCH) and a physical uplink shared channel (PUSCH). The DCI is carried by a physical downlink control channel (PDCCH). The UE decodes the DCI by performing blind detection on the PDCCH to obtain scheduling information included in the DCI.

In a case that the DCI schedules multiple data channels, since the DCI includes scheduling information for multiple data channels, once the UE cannot correctly decode the DCI, the UE will not be able to obtain the scheduling information for the multiple data channels. Therefore, it is expected that the UE can correctly decode the DCI. In addition, due to the large amount of content in the DCI, the difficulty of the UE performing blind detection on the PDCCH is increased.

Therefore, it is required to provide a technical solution to improve the probability of the UE correctly decoding DCI in a case that the DCI schedules multiple data channels, that is, to improve the reliability of transmission of the DCI.

### SUMMARY

A summary of the present disclosure is provided in this section, which is not a comprehensive disclosure of the full scope or all features of the present disclosure.

An object of the present disclosure is to provide an electronic device, a wireless communication method, and a computer readable storage medium, to improve the probability of a UE correctly decoding DCI when multiple data channels are scheduled by DCI, that is, to improve the reliability of transmission of the DCI.

According to an aspect of the present disclosure, an electronic device is provided. The electronic device includes processing circuitry configured to generate first downlink control information (DCI) including scheduling information for multiple data channels, and carry a plurality of the first DCIs using a data channel.

According to an aspect of the present disclosure, an electronic device is provided. The electronic device includes processing circuitry configured to receive a plurality of first downlink control information (DCIs) using a data channel, and soft-combine and decode the plurality of first DCIs to determine scheduling information for multiple data channels included in the first DCI.

According to an aspect of the present disclosure, a wireless communication method performed by an electronic device in a wireless communication system is provided. The method includes generating first downlink control information (DCI) including scheduling information for multiple data channels, and carrying a plurality of the first DCIs using a data channel.

According to an aspect of the present disclosure, a wireless communication method performed by an electronic device in a wireless communication system is provided. The method includes receiving a plurality of first downlink control information (DCIs) using a data channel, and soft-combining and decoding the plurality of first DCIs to determine scheduling information for multiple data channels included in the first DCI.

According to another aspect of the present disclosure, a computer readable storage medium is provided. The computer readable storage medium includes executable computer instructions that, when executed by a computer, cause the computer to perform the wireless communication method according to the present disclosure.

According to another aspect of the present disclosure, a computer program is provided. The computer program, when executed by a computer, causes the computer to perform the wireless communication method according to the present disclosure.

With the electronic device, the wireless communication method, and the computer readable storage medium according to the present disclosure, DCI including scheduling information of multiple data channels is carried by a data channel. In this way, the difficulty of the UE performing blind detection on PDCCH is not increased. Further, the data channel carries a plurality of DCIs. By doing this, the DCI including the same content is sent multiple times, and therefore the UE can soft-combine the plurality of DCIs, thereby improving the probability of correct decoding of the DCI. In summary, with the technical solution of the present disclosure, the reliability of transmission of DCI including scheduling information for multiple data channels can be improved.

Further areas of applicability will become apparent from the description provided herein. The description and specific examples in the summary are only illustrative and are not intended to limit the scope of the present disclosure.

### BRIEF DESCRIPTION OF THE DRAWINGS

The drawings described herein are for illustrating selected embodiments only rather than all possible implementations, and are not intended to limit the scope of the present disclosure. In the drawings:

FIG. 1 is a block diagram showing an example of configuration of an electronic device for a network side device according to an embodiment of the present disclosure;

FIG. 2 is a schematic diagram showing a design of carrying a plurality of first DCIs using a data channel according to an embodiment of the present disclosure, where each of the plurality of first DCIs schedules multiple consecutive data channels;

FIG. 3 is a schematic diagram showing a design of carrying a plurality of first DCIs using a data channel according to an embodiment of the present disclosure, where each of the plurality of first DCIs schedules multiple inconsecutive data channels;

FIG. 4 is a schematic diagram showing a design of carrying a plurality of first DCIs using a data channel according to an embodiment of the present disclosure, where each of the plurality of first DCIs schedules multiple consecutive PDSCHs;

FIG. 5 is a schematic diagram showing a design of carrying a plurality of first DCIs using a data channel according to an embodiment of the present disclosure, where each of the plurality of first DCIs schedules multiple consecutive PUSCHs;

FIG. 6 is a schematic diagram showing a design of carrying a plurality of first DCIs using a data channel according to an embodiment of the present disclosure, where each of the plurality of first DCIs schedules multiple consecutive PDSCHs and PUSCHs;

FIG. 7 is a schematic diagram showing a design of carrying a plurality of first DCIs using a data channel according to an embodiment of the present disclosure, where each of the plurality of first DCIs schedules multiple inconsecutive PDSCHs;

FIG. 8 is a schematic diagram showing a design of carrying a plurality of first DCIs using a data channel according to an embodiment of the present disclosure, where each of the plurality of first DCIs schedules multiple inconsecutive PUSCHs;

FIG. 9 is a schematic diagram showing a design of carrying a plurality of first DCIs using a data channel according to an embodiment of the present disclosure, where each of the plurality of first DCIs schedules multiple inconsecutive PDSCHs and PUSCHs;

FIG. 10 is a block diagram showing an example of configuration of an electronic device for user equipment according to an embodiment of the present disclosure;

FIG. 11 is a flowchart showing signaling between a network side device and user equipment according to an embodiment of the present disclosure;

FIG. 12 is a flowchart of a wireless communication method performed by an electronic device for a network side device according to an embodiment of the present disclosure;

FIG. 13 is a flowchart of a wireless communication method performed by an electronic device for user equipment according to an embodiment of the present disclosure;

FIG. 14 is a block diagram showing a first example of a schematic configuration of an Evolved Node B (eNB);

FIG. 15 is a block diagram showing a second example of a schematic configuration of an eNB;

FIG. 16 is a block diagram showing an example of a schematic configuration of a smartphone; and

FIG. 17 is a block diagram showing an example of a schematic configuration of a car navigation device.

Although various modifications and alternations are easily made to the present disclosure, specific embodiments of the present disclosure are shown in the drawings by examples, and are described in detail herein. It should be understood that description for the specific embodiments herein is not intended to limit the present disclosure to the specific form as disclosed. Instead, the present disclosure aims to cover all modifications, equivalents and alternations within the spirit and scope of the present disclosure. It is noted that throughout the drawings, corresponding reference numerals indicate corresponding parts

### DETAILED DESCRIPTION OF EMBODIMENTS

Examples of the present disclosure are fully disclosed with reference to the drawings. The following description is merely illustrative and is not intended to limit the present disclosure and applications or usage thereof.

Exemplary embodiments are provided so that the present disclosure becomes thorough and the scope thereof is fully conveyed to those skilled in the art. Numerous specific details such as examples of specific components, devices and methods are set forth to provide a thorough understanding of embodiments of the present disclosure. It is apparent for those skilled in the art that, exemplary embodiments may be implemented in various ways without these specific details, which should not be constructed as limiting the scope of the present disclosure. In some exemplary embodiments, well-known processes, structures and technologies are not described in detail.

Description is Made in the Following Order:
1. Description of problems;
2. Configuration example of a network side device;
3. Configuration example of user equipment;
4. Method embodiments; and
5. Application example.

### 1. Description of Problems

As mentioned above, in a case that the DCI schedules multiple data channels, since the DCI includes scheduling information for multiple data channels, once the UE cannot correctly decode the DCI, the UE will not be able to obtain the scheduling information for the multiple data channels. Therefore, it is expected that the UE can correctly decode the DCI. In addition, due to the large amount of content in the DCI, the difficulty of the UE performing blind detection on the PDCCH is increased if the DCI is still carried by the PDCCH.

Therefore, it is required to provide a technical solution to improve the probability of a UE correctly decoding the DCI in a case that the DCI schedules multiple data channels, that is, to improve the reliability of transmission of the DCI.

An electronic device in a wireless communication system, a wireless communication method performed by an electronic device in a wireless communication system, and a computer readable storage medium are provided according to the present disclosure to solve such problems, so as to improve the probability of a UE correctly decoding the DCI in a case that the DCI schedules multiple data channels, that is, to improve the reliability of transmission of the DCI.

The wireless communication system according to the present disclosure may be a 5G NR (New Radio) communication system or a 6G communication system.

The wireless communication system according to the present disclosure may be applied to a high-frequency band communication scenario. For example, the wireless communication system according to the present disclosure may be applied to a high frequency band from 52.6 GHz to 71 GHz. Apparently, with the development of technology, the wireless communication system according to the present disclosure may also be applied to other high frequency bands. In the high-frequency band communication scenario, a DCI is capable of scheduling multiple data channels. Therefore, how to ensure the reliability of transmission of DCI carrying scheduling information for multiple data channels is important.

A network side device according to the present disclosure may be a base station device, for example, an eNB, or a base station (gNB) in the fifth generation communication system.

User equipment according to the present disclosure may be a mobile terminal (such as a smartphone, a tablet personal computer (PC), a notebook PC, a portable game terminal, a portable/dongle-type mobile router, and a digital camera), or an in-vehicle terminal (such as a car navigation device). The user equipment may also be implemented as a terminal that performs machine-to-machine (M2M) communication (which is also referred to as a machine type communication (MTC) terminal). In addition, the user equipment may be a wireless communication module (such as an integrated circuit module including a single wafer) installed on each of the terminals described above.

### 2. Configuration Example of a Network Side Device

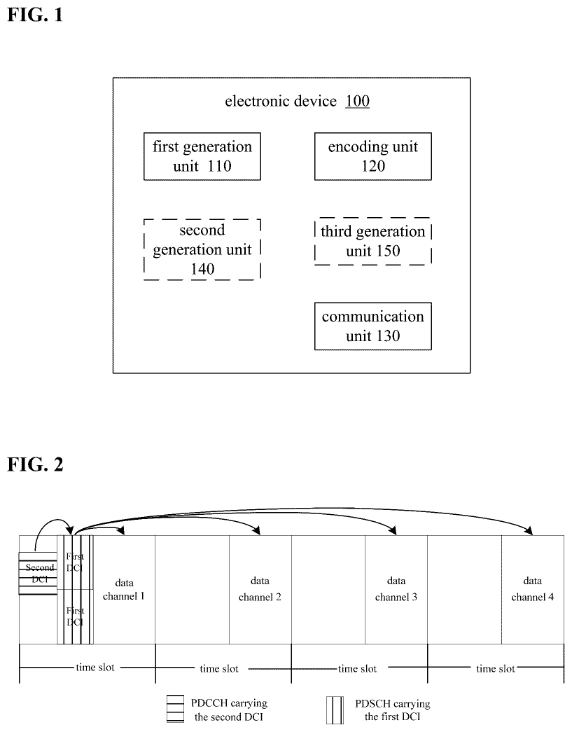

FIG. 2 is a block diagram showing an example of a configuration of an electronic device 100 according to an embodiment of the present disclosure. The electronic device 100 may be used as a network side device in a wireless communication system, and specifically may be used as a base station device in the wireless communication system.

As shown in FIG. 2, the electronic device 100 may include a first generation unit 110, an encoding unit 120, and a communication unit 130.

Here, each unit of the electronic device 100 may be included in a processing circuit. It should be noted that the electronic device 100 may include one processing circuitry or multiple processing circuits. Further, the processing circuitry may include various discrete functional units to perform different functions and/or operations. It should be noted that these functional units may be physical entities or logical entities, and units with different names may be implemented by the same physical entity.

According to an embodiment of the present disclosure, the first generation unit 110 is configured to generate first DCI including scheduling information of multiple data channels. That is, the first DCI is capable of scheduling multiple data channels.

According to an embodiment of the present disclosure, the encoding unit 120 is configured to encode various kinds of information generated by the electronic device 100. For example, the encoding unit 120 may perform data channel encoding on the first DCI generated by the first generation unit 110, that is, carrying the first DCI using a data channel.

According to an embodiment of the present disclosure, a plurality of first DCIs may be carried by a data channel. That is, the plurality of first DCIs are carried by multiple time-frequency resources on the data channel respectively.

According to an embodiment of the present disclosure, the electronic device 100 may transmit a plurality of first DCIs through the communication unit 130. Here, the electronic device 100 may send the plurality of first DCIs to a UE.

It can be seen that with the electronic device 100 according to the embodiments of the present disclosure, DCI including scheduling information of multiple data channels is carried by a data channel. In this way, the difficulty of the UE performing blind detection on PDCCH is not increased. Further, the data channel carries a plurality of DCIs. By doing this, the DCI including the same content is sent multiple times, and thus the UE can soft-combine the plurality of DCIs, thereby improving the probability of correct decoding of the DCI. In summary, with the technical solution of the present disclosure, the reliability of transmission of DCI including scheduling information for multiple data channels can be improved.

According to an embodiment of the present disclosure, the data channel carrying the first DCI may be a PDSCH.

According to an embodiment of the present disclosure, the electronic device 100 may further include a second generation unit 140 configured to generate second DCI. The second DCI includes information related to decoding a plurality of first DCIs.

According to an embodiment of the present disclosure, the encoding unit 120 may perform control channel encoding on the second DCI, that is, carry the second DCI using a control channel, and the control channel here may be a PDCCH.

As described above, according to the embodiments of the present disclosure, the second DCI is carried by a PDCCH, and the second DCI includes information related to decoding a plurality of first DCIs. The first DCI is carried by a PDSCH, and the first DCI is sent multiple times. In this way, the second DCI may have a size the same as a DCI carried by the existing PDCCH. That is, the second DCI is compatible with the existing DCI, and the difficulty of the UE performing blind detection on the PDCCH is therefore not increased.

According to an embodiment of the present disclosure, each of the multiple data channels scheduled by the first DCI may be an uplink data channel or a downlink data channel. That is, the multiple data channels scheduled by the first DCI may be all uplink data channels, or all downlink data channels. Alternatively, some of the multiple data channels scheduled by the first DCI may be uplink data channels, and the others may be downlink data channels. Here, the uplink data channel may be PUSCH, and the downlink data channel may be PDSCH.

According to an embodiment of the present disclosure, the multiple data channels scheduled by the first DCI may be consecutive or inconsecutive in the time domain. Here, if the multiple data channels scheduled by the first DCI are located in consecutive time slots in the time domain, the multiple data channels are consecutive in the time domain. If the multiple data channels scheduled by the first DCI are located in inconsecutive time slots in the time domain, the multiple data channels are inconsecutive in the time domain.

FIG. 2 is a schematic diagram showing a design of carrying a plurality of first DCIs using a data channel according to an embodiment of the present disclosure, where each of the plurality of first DCIs schedules multiple consecutive data channels. As shown in FIG. 2, the second DCI is carried by a PDCCH, and the first DCI is carried by a PDSCH. FIG. 2 shows that the first DCI is sent twice. Further, in FIG. 2, the first DCI schedules four data channels, namely, data channel 1, data channel 2, data channel 3, and data channel 4. The four data channels are located in four adjacent time slots. That is, any two adjacent data channels are located in adjacent time slots, so that the four data channels are consecutive. Apparently, the first DCI may also schedule a different number of data channels than four.

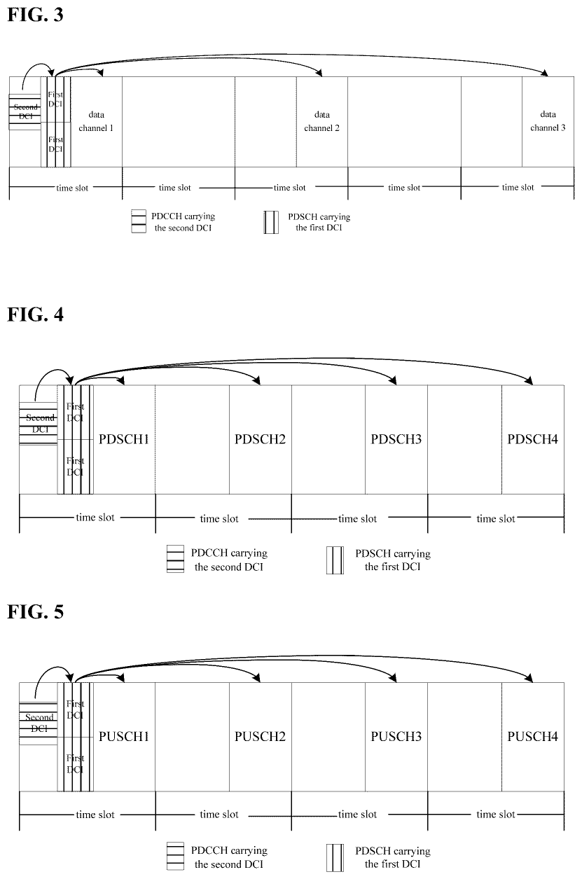

FIG. 3 is a schematic diagram showing a design of carrying a plurality of first DCIs using a data channel according to an embodiment of the present disclosure, where each of the plurality of first DCIs schedules multiple inconsecutive data channels. As shown in FIG. 3, the second DCI is carried by a PDCCH, and the first DCI is carried by a PDSCH. FIG. 3 shows that the first DCI is sent twice. Further, in FIG. 3, the first DCI schedules three data channels, namely, data channel 1, data channel 2, and data channel 3. There is a time slot between the data channel 1 and the data channel 2, and there is a time slot between the data channel 2 and the data channel 3. Therefore, the three data channels are inconsecutive. Apparently, the first DCI may also schedule a number of data channels other than three. In addition, as long as any two adjacent data channels are located in nonadjacent time slots, it is determined that the data channels scheduled by the first DCI are inconsecutive.

FIG. 4 is a schematic diagram showing a design of carrying a plurality of first DCIs using a data channel according to an embodiment of the present disclosure, where each of the plurality of first DCIs schedules multiple consecutive PDSCHs. In FIG. 4, the first DCI schedules four data channels, all of which are downlink data channels PDSCHs, namely, PDSCH1, PDSCH2, PDSCH3, and PDSCH4. The four data channels are consecutive in the time domain.

FIG. 5 is a schematic diagram showing a design of carrying a plurality of first DCIs using a data channel according to an embodiment of the present disclosure, where each of the plurality of first DCIs schedules multiple consecutive PUSCHs. In FIG. 5, the first DCI schedules four data channels, all of which are uplink data channels PUSCHs, namely, PUSCH1, PDSCH2, PUSCH3, and PUSCH4. The four data channels are consecutive in time domain.

FIG. 6 is a schematic diagram showing a design of carrying a plurality of first DCIs using a data channel according to an embodiment of the present disclosure, where each of the plurality of first DCIs schedules multiple consecutive PDSCHs and PUSCHs. In FIG. 6, the first DCI schedules four data channels, including two downlink data channels PDSCHs and two uplink data channels PUSCHs, namely, PDSCH1, PDSCH2, PUSCH3, and PUSCH4. The four data channels are consecutive in time domain.

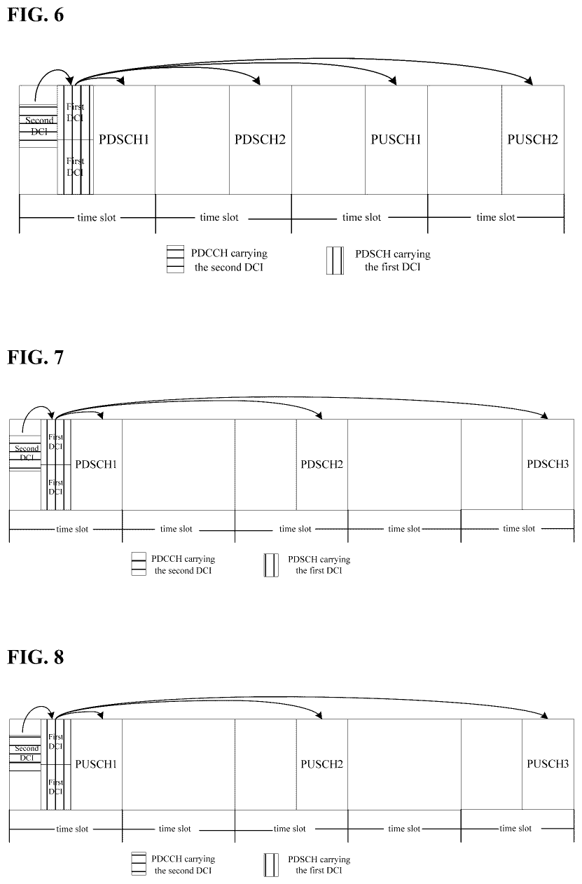

FIG. 7 is a schematic diagram showing a design of carrying a plurality of first DCIs using a data channel according to an embodiment of the present disclosure, where each of the plurality of first DCIs schedules multiple inconsecutive PDSCHs. In FIG. 7, the first DCI schedules three data channels, all of which are downlink data channels PDSCHs, namely, PDSCH1, PDSCH2, and PDSCH3. The three data channels are inconsecutive in time domain.

FIG. 8 is a schematic diagram showing a design of carrying plurality of first DCIs using a data channel according to an embodiment of the present disclosure, where each of the plurality of first DCIs schedules multiple inconsecutive PUSCHs. In FIG. 8, the first DCI schedules three data channels, all of which are uplink data channels PUSCHs, namely, PUSCH1, PUSCH2, and PUSCH3. The three data channels are inconsecutive in time domain.

FIG. 9 is a schematic diagram showing a design of carrying a plurality of first DCIs using a data channel according to an embodiment of the present disclosure, where each of the plurality of first DCIs schedules multiple inconsecutive PDSCHs and PUSCHs. In FIG. 9, the first DCI schedules three data channels, including two downlink data channels PDSCHs and one uplink data channel PDSCH, namely, PDSCH1, PDSCH2, and PUSCH1. The three data channels are inconsecutive in time domain.

Content in the second DCI is described in detail below.

### First Embodiment

According to an embodiment of the present disclosure, the second DCI may include indication information of a time-frequency position of each of the plurality of first DCIs.

Here, the time-frequency position of the first DCI may include a time-domain position and a frequency-domain position of the first DCI.

According to an embodiment of the present disclosure, the frequency-domain position of the first DCI may include a starting-subcarrier position and a length of consecutive subcarriers of the first DCI to indicate the frequency-domain position of the first DCI. For example, the electronic device 100 indicates that a starting-subcarrier position of the first DCI is 1 and the length of consecutive subcarriers is 3, then the UE may determine that the frequency-domain position of the first DCI is the subcarriers with serial numbers 1, 2, and 3. Apparently, if the frequency-domain resource is allocated in RB or other units, the frequency-domain position may also be indicated by RB or other units.

The time-domain position of the first DCI may include a time slot where the first DCI is located and a time-domain position of the first DCI in the time slot.

According to an embodiment of the present disclosure, the time slot where the first DCI is located may be indicated by a difference between the time slot where the first DCI is located and a time slot where the second DCI is located. In this way, the UE receiving the second DCI may determine the time slot wherein the first DCI is located based on the time slot where the second DCI is located and the above difference. For example, in a case that the second DCI is located in a time slot 2 and the electronic device 100 indicates that the above difference is 2, the UE determines that the first DCI is located in a time slot 4.

According to an embodiment of the present disclosure, the time-domain position of the first DCI in a time slot may be indicated by a starting-symbol position and a length of consecutive symbols of the first DCI in the time slot. For example, the electronic device 100 indicates that a starting-symbol position of the first DCI in a time slot is 1 and a length of consecutive symbols is 3, then the UE may determine that the time-domain position of the first DCI in the time slot corresponds to the OFDM symbols with serial numbers 1, 2 and 3. Thus, in combination with the time slot where the first DCI is located, the UE may determine that the time-domain position of the first DCI corresponds to the OFDM symbols with serial numbers 1, 2 and 3 in the time slot 4.

According to an embodiment of the present disclosure, the second DCI may include the time-frequency position of each first DCI in the manner described above. That is, the indication information includes the time-frequency position of each first DCI. That is, the content in the second DCI may be as shown in the following table.

TABLE 1

| | |
|---|---|
| time-frequency position of a 1^{st} first DCI | frequency-domain position of the 1^{st} first DCI |
| | time slot where the 1^{st} first DCI is located |
| | starting-symbol position of the 1^{st} first DCI |
| | length of consecutive symbols of the 1^{st} first |
| | DCI |
| time-frequency position of a 2^{nd} first DCI | frequency-domain position of the 2^{nd} first DCI |
| | time slot where the 2^{nd} first DCI is located |
| | starting-symbol position of the 2^{nd} first DCI |
| | length of consecutive symbols of the 2^{nd} first |
| | DCI |
| . . . | . . . |
| time-frequency position of a N^{th} first DCI | frequency-domain position of the N^{th} first DCI |
| | time slot where the Nth first DCI is located |
| | starting-symbol position of the N^{th} first DCI |
| | length of consecutive symbols of the N^{th} first |
| | DCI |

N represents the number of the first DCIs.

As described above, the second DCI implicitly indicates the number of the plurality of first DCIs carried by the data channel, that is, the number of times the first DCI is repeatedly sent. In other words, the number of time-frequency positions of the first DCI included in the second DCI is equal to the number of the first DCIs.

As described above, in the first embodiment, UE can determine the number of the first DCIs and the time-frequency positions of the respective first DCIs based on the content in the second DCI. Since the second DCI indicates the time-frequency positions of the respective first DCIs, the second DCI can accurately indicate the positions of the respective first DCIs regardless of distribution of the respective of first DCIs in time domain and frequency domain.

### Variant of the First Embodiment

According to an embodiment of the present disclosure, the time-frequency position of each of a plurality of first DCIs may also be indicated by modifying a resource allocation table. For example, the electronic device 100 may configure the resource allocation table through RRC signaling, so that the indication information of the time-frequency position of each of the plurality of first DCIs included in the second DCI corresponds to multiple resource positions. In this way, the UE receiving the second DCI may look up the resource allocation table and determine the multiple resource positions as the time-frequency position of the plurality of first DCIs based on the indication information.

As described above, in the variant of the first embodiment, the UE can determine the number of the first DCIs and the time-frequency position of each first DCI based on the indication information in the second DCI. In this way, the second DCI can be compatible with a format and a size of a DCI carried by the PDCCH in the existing standards.

### Second Embodiment

According to an embodiment of the present disclosure, the second DCI may include a time-frequency position of one of a plurality of first DCIs. Similarly, the time-frequency position of the one first DCI may include a time-domain position and a frequency-domain position of the 1^{st} first DCI. Further, the time-domain position of the one first DCI may include a time slot where the one first DCI is located and a time-domain position of the 1^{st} first DCI in the time slot.

According to an embodiment of the present disclosure, the one first DCI may be any one of the plurality of first DCIs, for example, the Pt first DCI.

That is, the content in the second DCI may be as shown in the following table.

TABLE 2

| | |
|---|---|
| time-frequency position of one first DCI | frequency-domain position of the one first DCI |
| | time slot where the one first DCI is located |
| | starting-symbol position of the one first DCI |
| | length of consecutive symbols of the one first |
| | DCI |

As shown in FIG. 1, according to an embodiment of the present disclosure, the electronic device 100 may further include a third generation unit 150 configured to generate control information other than the first DCI and the second DCI. For example, other control information may be high-level signaling such as RRC signaling, or may be the third DCI other than the first DCI and the second DCI.

According to an embodiment of the present disclosure, other control information may include the number of the plurality of first DCIs and time-frequency position of each first DCI other than one first DCI. That is, assuming that the second DCI includes the time-frequency position of the 1^{st} first DCI, the content in other control information may be as shown in the following table.

TABLE 3

| | |
|---|---|
| the number of first DCIs | N |
| time-frequency position of a 2^{nd} first DCI | frequency-domain position of the 2^{nd} first DCI |
| | time slot where the 2^{nd} first DCI is located |
| | starting-symbol position of the 2^{nd} first DCI |
| | length of consecutive symbols of the 2^{nd} first |
| | DCI |
| . . . | . . . |
| time-frequency position of a N^{th} first DCI | frequency-domain position of the N^{th} first DCI |
| | time slot where the N^{th} first DCI is located |
| | starting-symbol position of the N^{th} first DCI |
| | length of consecutive symbols of the N^{th} first |
| | DCI |

As described above, in the second embodiment, the UE can determine the number of the first DCIs and the time-frequency positions of the respective first DCIs based on the content in the second DCI and the content in other control information. Since the second DCI includes only the time-frequency position of the 1^{st} first DCI, the second DCI is compatible with the format and the size of the DCI carried by the PDCCH in the existing standards.

### Variant 1 of the Second Embodiment

According to an embodiment of the present disclosure, if a frequency-domain position of a certain first DCI is not included in other control information, the UE may determine that the frequency-domain position of the certain first DCI is the same as a frequency-domain position of the first DCI included in the second DCI. Similarly, if a starting-symbol position and/or a length of consecutive symbols of a certain first DCI are not included in other control information, the UE may determine that the starting-symbol position and/or the length of consecutive symbols of the certain first DCI are the same as a starting-symbol position and/or a length of consecutive symbols of the first DCI included in the second DCI.

For example, the second DCI includes the time-frequency position of the 1^{st} first DCI, and a time-frequency position of a 2^{nd} first DCI in other control information includes only a time slot where the 2^{nd} first DCI is located, a starting-symbol position of the 2^{nd} first DCI, and a length of consecutive symbols of the 2^{nd} first DCI. The UE may determine a time-domain position of the 2^{nd} first DCI based on the above information and determines that a frequency-domain position of the 2^{nd} first DCI is the same as the frequency-domain position of the 1^{st} first DCI.

For another example, the second DCI includes the time-frequency position of the 1^{st} first DCI, and a time-frequency position of a 2^{nd} first DCI in other control information includes only a frequency-domain position of the 2^{nd} first DCI and a time slot where the 2^{nd} first DCI is located. The UE may determine a frequency-domain position of the 2^{nd} first DCI based on the above information, determine that a starting-symbol position and a length of consecutive symbols of the 2^{nd} first DCI are the same as the starting-symbol position and the length of consecutive symbols of the 1^{st} first DCI, and determine a time-domain position of the 2^{nd} first DCI in combination with the time slot where the 2^{nd} first DCI is located.

For another example, the second DCI includes the time-frequency position of the 1^{st} first DCI, and a time-frequency position of a 2^{nd} first DCI in other control information includes only a time slot where the 2^{nd} first DCI is located. The UE may determine that a frequency-domain position of the 2^{nd} first DCI is the same as the frequency-domain position of the 1^{st} first DCI, determine that a starting-symbol position and a length of consecutive symbols of the 2^{nd} first DCI are the same as the starting-symbol position and the length of consecutive symbols of the 1^{st} first DCI, and determine a time-domain position of the 2^{nd} first DCI in combination with the time slot where the 2^{nd} first DCI is located.

As described above, according to the embodiments of the present disclosure, when a time-domain position or a frequency-domain position of one or more first DCIs is the same as a time-domain position or a frequency-domain position of the first DCI included in the second DCI, parameters of time-domain positions or frequency-domain positions of other first DCI may be omitted, thereby saving overhead.

### Variant 2 of the Second Embodiment

According to an embodiment of the present disclosure, in a case that the time-domain positions or the frequency-domain positions of the multiple first DCIs exhibit a certain regularity, other control information may include the number of the multiple first DCIs and the relationship between the time-frequency positions of the multiple first DCIs.

According to an embodiment of the present disclosure, the relationship between the time-frequency positions of the multiple first DCIs may include a time-domain cycle and/or a frequency-domain cycle of the multiple first DCIs. For example, in a case that the relationship between the time-frequency positions of the multiple first DCIs includes the time-domain cycle of the multiple first DCIs, it may be considered that the frequency-domain positions of the multiple first DCIs are the same, and the first DCIs are arranged in time domain in the time-domain cycle. In a case that the relationship between the time-frequency positions of the multiple first DCIs includes the frequency-domain cycle of the multiple first DCIs, it may be considered that the time-domain positions of the multiple first DCIs are the same, and the first DCIs are arranged in frequency domain in the frequency-domain cycle. In a case that the relationship between the time-frequency positions of the multiple first DCIs includes the time-domain cycle and the frequency-domain cycle of the multiple first DCIs, it may be considered that the multiple first DCIs are arranged in time domain in the time-domain cycle and arranged in frequency domain in the frequency-domain cycle.

For example, the second DCI includes the time-frequency position of the 1^{st} first DCI, and other control information includes a time-domain cycle of 5. The UE may determine the time-frequency position of the 1^{st} first DCI based on the second DCI, and then determine that the frequency-domain position of the 2^{nd} first DCI is the same as the frequency-domain position of the 1^{st} first DCI. Further, the UE increases the starting-symbol position of the first DCI by 5 OFDM symbols to obtain the starting-symbol position of the 2^{nd} first DCI, and takes the length of consecutive symbols of the 1^{st} first DCI as a length of consecutive symbols of the 2^{nd} first DCI, so as to determine the time-domain position of the 2^{nd} first DCI.

As another example, the second DCI includes the time-frequency position of the 1^{st} first DCI, and other control information includes a frequency-domain cycle of 6. The UE may determine the time-frequency position of the 1^{st} first DCI based on the second DCI, and then determine that the time-domain position of the 2^{nd} first DCI is the same as the time-domain position of the 1^{st} first DCI. Further, the UE increases a starting-subcarrier position of the 1^{st} first DCI by 6 subcarriers to obtain a starting-subcarrier position of the 2^{nd} first DCI, and takes a length of consecutive subcarriers of the 1^{st} first DCI as a length of consecutive subcarriers of the 2^{nd} first DCI, so as to determine the frequency-domain position of the 2^{nd} first DCI.

According to an embodiment of the present disclosure, multiple first DCIs may be located in the same time slot or located in different time slots. In the above embodiments, in a case that the multiple first DCIs are located in different time slots, other control information may further include time slots where other first DCIs than the first DCI included in the second DCI are located.

As described above, according to the embodiments of the present disclosure, in a case that the time-frequency positions of the multiple first DCIs exhibit a certain regularity, other control information may include only relationship information indicating the regularity, thereby saving overhead.

### Third Embodiment

According to an embodiment of the present disclosure, other control information may include the time-frequency position of each of the multiple first DCIs. This embodiment is similar to the first embodiment, except that the time-frequency position of each first DCI is carried by other control information. That is, other control information may include the content shown in Table 1. For example, other control information may be high-level signaling such as RRC signaling, or may be a third DCI other than the first DCI and the second DCI.

Similarly, other control information implicitly indicates the number of the first DCIs carried by the data channel, that is, the number of times the first DCI is repeatedly sent. In other words, the number of time-frequency positions of the first DCI included in the other control information is equal to the number of the first DCIs.

As described above, in the third embodiment, the UE may determine the number of the first DCIs and the time-frequency positions of the first DCIs based on other control information. In this embodiment, the second DCI can be compatible with the format and the size of the DCI carried in the PDCCH in the existing standard. In addition, since the time-frequency positions of the first DCIs are not included in the second DCI, bits for indicating the time-frequency positions may be reserved in the second DCI.

In the above three embodiments, the second DCI may further include modulation and coding scheme (MCS) for the first DCI and/or transmission configuration indicator (TCI) for the first DCI. In addition, the second DCI may further include other information related to decoding the first DCI.

The content in the second DCI is described in detail above. According to an embodiment of the present disclosure, the size of the second DCI may be the same as a size of the DCI carried by the PDCCH in the existing standards, and content in the second DCI may be compatible with content in the DCI carried by the PDCCH in the existing standard, thereby avoiding a change to the existing standards.

The content in the first DCI is described in detail below. The first DCI may include scheduling information of multiple data channels.

According to an embodiment of the present disclosure, the scheduling information of the multiple data channels may include position information related to the time-frequency position of each of the multiple data channels.

### First Embodiment

According to an embodiment of the present disclosure, the position information may include a time slot where each data channel is located, a time-domain position of each data channel in a time slot, and a frequency-domain position of each data channel.

According to an embodiment of the present disclosure, a frequency-domain position of a data channel may include a starting-subcarrier position and a length of consecutive subcarriers of the data channel. For example, a starting-subcarrier position of a data channel is 1 and a length of consecutive subcarriers of the data channel is 3, then the UE may determine that a frequency-domain position of the data channel is subcarriers with serial numbers 1, 2, and 3. Apparently, if the frequency-domain resource is allocated in RB or other units, the frequency-domain position may also be indicated by RB or other units.

According to an embodiment of the present disclosure, a time slot where a data channel is located may be indicated by a difference between the time slot where the data channel is located and a time slot where the first DCI is located. In this way, the UE receiving the first DCI may determine the time slot where the data channel is located based on the time slot where the first DCI is located and the difference. For example, the first DCI is located in time slot 2 and the electronic device 100 indicates that the difference is 2, then the UE may determine that the data channel is located in time slot 4.

According to an embodiment of the present disclosure, a time-domain position of a data channel in a time slot may be indicated by a starting-symbol position and a length of consecutive symbols of the data channel in the time slot. For example, the electronic device 100 indicates that a starting-symbol position of a data channel in a time slot is 1 and a length of consecutive symbols of the data channel is 3, then the UE can determine OFDM symbols of the data channel at time-domain positions with serial numbers 1, 2 and 3 in a time slot. Thus, in combination with the time slot where the data channel is located, the UE can determine OFDM symbols of the data channel at the time-domain positions with serial numbers 1, 2 and 3 in the time slot 4.

According to an embodiment of the present disclosure, the first DCI may include the time-frequency position of each data channel in the manner described above. That is, the content in the first DCI may be as shown in the following table.

TABLE 4

| | |
|---|---|
| time-frequency position of a 1^{st} data | frequency-domain position of the 1^{st} data |
| channel | channel |
| | time slot where the 1^{st} data channel is located |
| | starting-symbol position of the 1^{st} data channel |
| | length of consecutive symbols of the 1^{st} data |
| | channel |
| time-frequency position of a 2^{nd} data | frequency-domain position of the 2^{nd} data |
| channel | channel |
| | time slot where the 2^{nd} data channel is located |
| | starting-symbol position of the 2^{nd} data channel |
| | length of consecutive symbols of the 1^{st} data |
| | channel of the 2^{nd} data channel |
| . . . | . . . |
| time-frequency position of an M^{th} data | frequency-domain position of the M^{th} data |
| channel | channel |
| | time slot where the M^{th} data channel is located |
| | starting-symbol position of the M^{th} data channel |
| | length of consecutive symbols of the 1^{st} data |
| | channel of the M^{th} data channel |

M represents the number of the data channels scheduled by the first DCI.

According to an embodiment of the present disclosure, the scheduling information for the multiple data channels may further include uplink-downlink indication information. The uplink-downlink indication information indicates whether each of the multiple data channels is an uplink data channel or a downlink data channel.

According to an embodiment of the present disclosure, in a case that the multiple data channels are all downlink data channels or all uplink data channels, such information may be represented by one bit in the first DCI. For example, when the bit is 1, it indicates that the multiple data channels scheduled by the first DCI are downlink data channels. When the bit is 0, it indicates that the multiple data channels scheduled by the first DCI are uplink data channels. In a case that a portion of the multiple data channels are downlink data channels and the other portion are uplink data channels, such bit may be set for each data channel.

According to an embodiment of the present disclosure, the first DCI may further include a data-channel-type indication for indicating whether the multiple data channels scheduled by the first DCI are of the same type. For example, such information may be represented by one bit. In a case that the multiple data channels are all downlink data channels or all uplink data channels, the bit is 1. In a case that a portion of the multiple data channels are downlink data channels and the other portion are uplink data channels, the bit is 0.

The following table shows the content in the first DCI in a case that the multiple data channels are all downlink data channels.

TABLE 5

| | |
|---|---|
| data-channel-type indication | 1 |
| uplink-downlink indication information | 1 |
| time-frequency position of a 1^{st} PDSCH | frequency-domain position of the 1^{st} PDSCH |
| | time slot where the 1^{st} PDSCH is located |
| | starting-symbol position of the 1^{st} PDSCH |
| | length of consecutive symbols of the 1^{st} PDSCH |
| time-frequency position of a 2^{nd} PDSCH | frequency-domain position of the 2^{nd} PDSCH |
| | time slot where the 2^{nd} PDSCH is located |
| | starting-symbol position of the 2^{nd} PDSCH |
| | length of consecutive symbols of the 2^{nd} PDSCH |
| . . . | . . . |
| time-frequency position of an M^{th} | frequency-domain position of the M^{th} PDSCH |
| PDSCH | time slot where the M^{th} PDSCH is located |
| | starting-symbol position of the M^{th} PDSCH |
| | length of consecutive symbols of the M^{th} PDSCH |

The following Table shows the content in the first DCI in a case that the multiple data channels are all uplink data channels.

TABLE 6

| | |
|---|---|
| data-channel-type indication | 1 |
| uplink-downlink indication information | 0 |
| time-frequency position of a 1^{st} PUSCH | frequency-domain position of the 1^{st} PUSCH |
| | time slot where the 1^{st} PUSCH is located |
| | starting-symbol position of the 1^{st} PUSCH |
| | length of consecutive symbols of the 1^{st} |
| | PUSCH |
| time-frequency position of a 2^{nd} PUSCH | frequency-domain position of the 2^{nd} PUSCH |
| | time slot where the 2^{nd} PUSCH is located |
| | starting-symbol position of the 2^{nd} PUSCH |
| | length of consecutive symbols of the 2^{nd} |
| | PUSCH |
| . . . | . . . |
| time-frequency position of an M^{th} PUSCH | frequency-domain position of the M^{th} |
| | PUSCH |
| | time slot where the Mth PUSCH is located |
| | starting-symbol position of the M^{th} PUSCH |
| | length of consecutive symbols of the M^{th} |
| | PUSCH |

The following table shows the content in the first DCI in a case that a portion of the multiple data channels are the downlink data channels and the other portion are uplink data channels.

TABLE 7

| | |
|---|---|
| data-channel-type indication | 0 |
| uplink-downlink indication information | |
| uplink-downlink indication of a 1^{st} data | 1 |
| channel | |
| time-frequency position of the 1^{st} data | frequency-domain position of the 1^{st} data |
| channel | channel |
| | time slot where the 1^{st} data channel is located |
| | starting-symbol position of the 1^{st} data channel |
| | length of consecutive symbols of the 1^{st} data |
| | channel |
| uplink-downlink indication of a 2^{nd} data | 1 |
| channel | |
| time-frequency position of the 2^{nd} data | frequency-domain position of the 2^{nd} data |
| channel | channel |
| | time slot where the 2^{nd} data channel is located |
| | starting-symbol position of the 2^{nd} data channel |
| | length of consecutive symbols of the 2^{nd} data |
| | channel |
| . . . | . . . |
| uplink-downlink indication of an M^{th} data | 0 |
| channel | |
| time-frequency position of the M^{th} data | frequency-domain position of the M^{th} data |
| channel | channel |
| | time slot where the M^{th} data channel is located |
| | starting-symbol position of the M^{th} data channel |
| | length of consecutive symbols of the M^{th} data |
| | channel |

As described above, according to the embodiments of the present disclosure, the first DCI may include a time-domain position and a frequency-domain position of each data channel. Therefore, the first DCI can accurately indicate the position of each data channel regardless of how the data channels are distributed in time domain and frequency domain.

### Second Embodiment

According to an embodiment of the present disclosure, the position information may include a time slot where each data channel is located, a time-domain position of one of multiple data channels in a time slot, and a frequency-domain position of one data channel.

According to an embodiment of the present disclosure, the scheduling information for multiple data channels may further include the number of data channels scheduled by the first DCI. In a case that all data channels scheduled by the first DCI are downlink data channels, the scheduling information of the multiple data channels may include the number of all downlink data channels scheduled by the first DCI. In a case that all data channels scheduled by the first DCI are uplink data channels, the scheduling information of the multiple data channels may include the number of all uplink data channels scheduled by the first DCI. In a case that a portion of the data channels scheduled by the first DCI are downlink data channels and the other portion are uplink data channels, the scheduling information of the multiple data channels may include the number of all downlink data channels scheduled by the first DCI and the number of all uplink data channels scheduled by the first DCI.

As described above, according to an embodiment of the present disclosure, the first DCI may include only a time-frequency position of one data channel and time slots where the other data channels are located. The UE, when receiving this first DCI, may determine that frequency-domain positions of the other data channels are the same as the frequency-domain position of the one data channel, and determine that time-domain positions of the other data channels in a time slot are the same as the time-domain position of the one data channel in a time slot, so as to determine the time-domain positions of the other data channels.

The following table shows the content in the first DCI.

TABLE 8

| | |
|---|---|
| the number of data channels | M |
| time-frequency position of a 1^{st} data channel | frequency-domain position of the 1^{st} data |
| | channel |
| | time slot where the 1^{st} data channel is located |
| | starting-symbol position of the 1^{st} data |
| | channel |
| | length of consecutive symbols of the 1^{st} data |
| | channel |
| time slot where a 2^{nd} data channel is located | time slot where the 2^{nd} data channel is located |
| . . . | . . . |
| time slot where an M^{th} data channel is located | time slot where the M^{th} data channel is |
| | located |

According to an embodiment of the present disclosure, the scheduling information of multiple data channels may further include uplink-downlink indication information. The uplink-downlink indication information indicates whether each of the multiple data channels is an uplink data channel or a downlink data channel.

According to an embodiment of the present disclosure, in a case that the multiple data channels are all downlink data channels or all uplink data channels, such information may be indicated by one bit in the first DCI. For example, when the bit is 1, it indicates that the multiple data channels scheduled by the first DCI are all downlink data channels. When the bit is 0, it indicates that the multiple data channels scheduled by the first DCI are all uplink data channels. In a case that a portion of the multiple data channels are downlink data channels and the other portion are uplink data channels, such bit may be set for each data channel.

According to an embodiment of the present disclosure, the first DCI may further include a data-channel type indication to indicate whether the multiple data channels scheduled by the first DCI are of the same type. For example, such information may be represented by one bit. In a case that the multiple data channels are all downlink data channels or all uplink data channels, the bit is 1. In a case that a portion of the multiple data channels are downlink data channels and the other portion are uplink data channels, the bit is 0.

The following table shows the content in the first DCI in a case that the multiple data channels are downlink data channels.

TABLE 9

| | |
|---|---|
| data-channel type indication | 1 |
| uplink-downlink indication information | 1 |
| the number of PDSCHs | M |
| time-frequency position of a 1^{st} PDSCH | frequency-domain position of the 1^{st} PDSCH |
| | time slot where the 1^{st} PDSCH is located |
| | starting-symbol position of the 1^{st} PDSCH |
| | length of consecutive symbols of the 1^{st} |
| | PDSCH |
| time slot where a 2^{nd} PDSCH is located | time slot where the 2^{nd} PDSCH is located |
| . . . | . . . |
| time-frequency position of an M^{th} PDSCH | time-frequency position of the M^{th} PDSCH |

The following table shows the content in the first DCI in a case that the multiple data channels are all uplink data channels.

TABLE 10

| | |
|---|---|
| data-channel type indication | 1 |
| uplink-downlink indication information | 0 |
| the number of PUSCHs | M |
| time-frequency position of a 1^{st} PUSCH | frequency-domain position of the 1^{st} PUSCH |
| | time slot where the 1^{st} PUSCH is located |
| | starting-symbol position of the 1^{st} PUSCH |
| | length of consecutive symbols of the 1^{st} |
| | PUSCH |
| time slot where a 2^{nd} PUSCH is located | time slot where the 2^{nd} PUSCH is located |
| . . . | . . . |
| time-frequency position of an M^{th} PUSCH | time-frequency position of the M^{th} PUSCH |

The following table shows the content in the first DCI in a case that a portion of the multiple data channels are downlink data channels and the other portion are uplink data channels.

TABLE 11

| | |
|---|---|
| data-channel type indication | 0 |
| uplink-downlink indication information | |
| the number of PDSCHs | P |
| uplink-downlink indication of a 1^{st} PDSCH | 1 |
| time-frequency position of the 1^{st} PDSCH | frequency-domain position of the 1^{st} PDSCH |
| | time slot where the 1^{st} PDSCH is located |
| | starting-symbol position of the 1^{st} PDSCH |
| | length of consecutive symbols of the 1^{st} |
| | PDSCH |
| uplink-downlink indication of a 2^{nd} PDSCH | 1 |
| time slot where the 2^{nd} PDSCH is located | time slot where the 2^{nd} PDSCH is located |
| . . . | . . . |
| uplink-downlink indication of a P^{th} PDSCH | 1 |
| time slot where the P^{th} PDSCH is located | time slot where the P^{th} PDSCH is located |
| the number of PUSCHs | Q |
| uplink-downlink indication of a 1^{st} PUSCH | 0 |
| time-frequency position of the 1^{st} PUSCH | frequency-domain position of the 1^{st} PUSCH |
| | time slot where the 1^{st} PUSCH is located |
| | starting-symbol position of the 1^{st} PUSCH |
| | length of consecutive symbols of the 1^{st} |
| | PUSCH |
| uplink-downlink indication of a 2^{nd} PUSCH | 0 |
| time slot where the 2^{nd} PUSCH is located | time slot where the 2^{nd} PUSCH is located |
| . . . | . . . |
| uplink-downlink indication of a Q^{th} PUSCH | 0 |
| time slot where the Q^{th} PUSCH is located | time slot where the Q^{th} PUSCH is located |

As described above, according to an embodiment of the present disclosure, in a case that the multiple data channels have the same frequency-domain position and have the same time-domain position in a time slot, the first DCI may include only a frequency-domain position and a time-domain position in a time slot for one data channel, thereby reducing the overhead of the first DCI.

In addition, in the above two embodiments, the first DCI may further include indication information indicating whether multiple data channels scheduled by the first DCI are consecutive. For example, the first DCI may include such 1-bit indication information. When the indication information is 0, it indicates that the multiple data channels scheduled by the first DCI are inconsecutive. When the indication information is 1, it indicates that the multiple data channels scheduled by the first DCI are consecutive.

According to an embodiment of the present disclosure, in a case that multiple data channels scheduled by the first DCI are consecutive, the first DCI may include a time slot where the first data channel is located without including time slots where the other data channels are located. The UE receiving the first DCI may determine the time slots where the other data channels are located based on the time slot where the first data channel is located. In this way, the overhead of the first DCI can further be reduced.

In addition, according to an embodiment of the present disclosure, the first DCI may further include one or more of the following information for decoding data channels: MCS of the data channels, TCI status indication of the data channels, and identification information of the data channels.

It can be seen that according to the embodiments of the present disclosure, the DCI including the scheduling information for multiple data channels may be carried by a data channel, and the DCI carried by the PDCCH indicates information related to decoding the DCI. In this way, the difficulty of the UE performing blind detection on the PDCCH is not increased. Further, multiple DCIs are carried by a data channel. In this way, since the DCI is sent multiple times, the UE can soft-combine multiple DCIs, thereby improving the probability of correctly decoding the DCI. In addition, the content in the two types of DCI can be flexibly designed. In short, the reliability of transmission of the DCI including the scheduling information for the multiple data channels can be improved with the technical solutions according to the present disclosure.

### 3. Example of Configuration for User Equipment

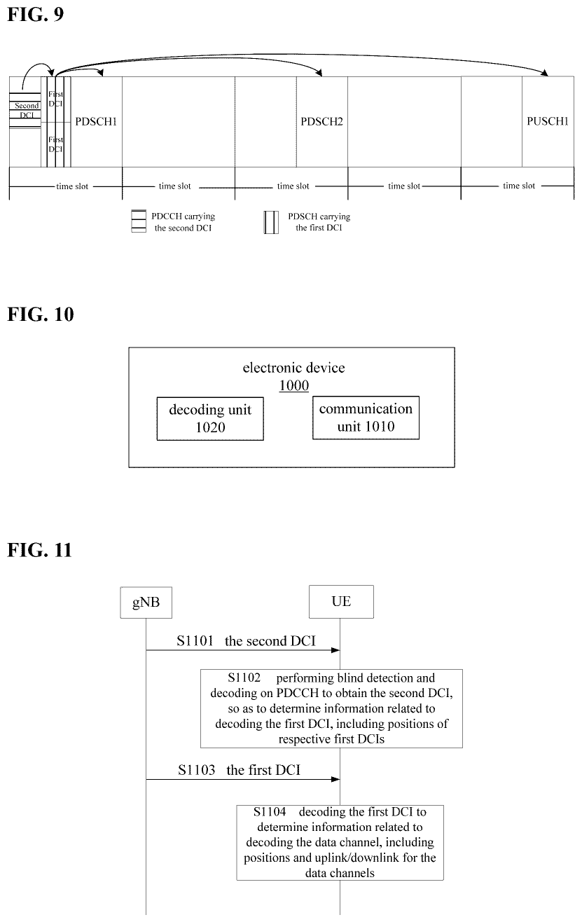

FIG. 10 is a block diagram showing an example of configuration of an electronic device 1000 serving as user equipment in a wireless communication system according to an embodiment of the present disclosure.

As shown in FIG. 10, the electronic device 1000 may include a decoding unit 1020 and a communication unit 1010.

Here, each unit of the electronic device 1000 may be included in a processing circuit. It should be noted that the electronic device 1000 may include one processing circuitry or multiple processing circuits. Further, the processing circuitry may include various discrete functional units to perform different functions and/or operations. It should be noted that these functional units may be physical entities or logical entities, and units with different names may be implemented by the same physical entity.

According to an embodiment of the present disclosure, the electronic device 1000 may receive multiple first DCIs using a data channel through the communication unit 1010.

According to an embodiment of the present disclosure, the decoding unit 1020 may soft-combine and decode the multiple first DCIs to determine scheduling information for multiple data channels included in the first DCI.

It can be seen that according to the embodiments of the present disclosure, the electronic device 1000 can receive the DCI including the scheduling information for multiple data channels using a data channel, without increasing the difficulty of performing blind detection on the PDCCH. Further, the data channel carries multiple DCIs, and the electronic device 1000 can soft-combine the multiple DCIs, thereby improving the probability of correctly decoding the DCI.

According to an embodiment of the present disclosure, each of the multiple data channels scheduled by the first DCI may be an uplink data channel or a downlink data channel, and the multiple data channels may be consecutive or inconsecutive in time domain.

According to an embodiment of the present disclosure, the electronic device 1000 may further receive second DCI through the communication unit 1010. The decoding unit 1020 may further perform blind detection and decoding on the control channel to determine the second DCI, and determine information related to decoding the multiple first DCIs based on the second DCI. The control channel here may be PDCCH.

A process of decoding the second DCI by the decoding unit 1020 is described below.

### First Embodiment

According to an embodiment of the present disclosure, the decoding unit 1020 may perform blind detection and decoding on the PDCCH to determine the second DCI. The second DCI includes indication information of a time-frequency position of each of the multiple first DCIs, and the indication information includes a time-frequency position of each first DCI.

That is, the second DCI may have for example the structure shown in Table 1, and the decoding unit 1020 may successively determine the time-frequency positions of the respective first DCIs based on the content in the second DCI.

### Variant of the First Embodiment

According to an embodiment of the present disclosure, the decoding unit 1020 may perform blind detection and decoding on the PDCCH to determine the second DCI. The second DCI includes the indication information of the time-frequency position of each of the multiple first DCIs, and the indication information corresponds to the multiple time-frequency positions. The decoding unit 1020 looks up the resource allocation table previously received through RRC signaling, to determine multiple time-frequency positions corresponding to the indication information as the time-frequency positions of the multiple first DCIs.

### Second Embodiment

According to an embodiment of the present disclosure, the decoding unit 1020 may perform blind detection and decoding on the PDCCH to determine the second DCI. The second DCI includes a time-frequency position of one of the multiple first DCIs.

According to an embodiment of the present disclosure, the electronic device 1000 may further receive other control information through the communication unit 1010. Other control information includes but is not limited to RRC signaling, and a third DCI other than the first DCI and the second DCI. Further, the decoding unit 1020 may decode other control information to determine the number of multiple first DCIs and the time-frequency position of each first DCI other than the first DCI included in the second DCI.

That is, the second DCI may have for example the structure shown in Table 2, and other control information may have for example the structure shown in Table 3. The decoding unit 1020 may determine the time-frequency position of one first DCI based on the second DCI, and determine the time-frequency positions of the other first DCIs based on other control information.

### Variant 1 of the Second Embodiment

According to an embodiment of the present disclosure, the decoding unit 1020 may perform blind detection and decoding on the PDCCH to determine the second DCI. The second DCI includes the time-frequency position of one of the multiple first DCIs.

According to an embodiment of the present disclosure, if a frequency-domain position of a certain first DCI is not included in other control information, the electronic device 1000 may determine that the frequency-domain position of the certain first DCI is the same as a frequency-domain position of the first DCI included in the second DCI. Similarly, if a starting-symbol position and/or a length of consecutive symbols of a certain first DCI are not included in other control information, the electronic device 1000 may determine that the starting-symbol position and/or the length of consecutive symbols of the certain first DCI are the same as a starting-symbol position and/or a length of consecutive symbols of the first DCI included in the second DCI.

### Variant 2 of the Second Embodiment

According to an embodiment of the present disclosure, the decoding unit 1020 may perform blind detection and decoding on the PDCCH to determine the second DCI. The second DCI includes a time-frequency position of one of the multiple first DCIs.

According to an embodiment of the present disclosure, the decoding unit 1020 may decode other control information to determine the number of the multiple first DCIs and a relationship between the time-frequency positions of the multiple first DCIs. Further, the decoding unit 1020 may determine time-frequency positions of other first DCIs based on the time-frequency position of the first DCI included in the second DCI, the number of the multiple first DCIs, and the relationship between the time-frequency positions of the multiple first DCIs.

According to an embodiment of the present disclosure, the relationship between the time-frequency positions of the multiple first DCIs may include a time-domain cycle and/or a frequency-domain cycle of the multiple first DCIs. For example, in a case that the relationship between the time-frequency positions of the multiple first DCIs includes the time-domain cycle of the multiple first DCIs, the electronic device 1000 may determine that the frequency-domain positions of the multiple first DCIs are the same, and the first DCIs are arranged in time domain in the time-domain cycle. In a case that the relationship between the time-frequency positions of the multiple first DCIs includes the frequency-domain cycle of the multiple first DCIs, the electronic device 1000 may determine that the time-domain positions of the multiple first DCIs are the same, and the first DCIs are arranged in frequency domain in the frequency-domain cycle. In a case that the relationship between the time-frequency positions of the multiple first DCIs includes the time-domain cycle and the frequency-domain cycle of the multiple first DCIs, the electronic device 1000 may determine that the multiple first DCIs are arranged in time domain in the time-domain cycle and arranged in frequency domain in the frequency-domain cycle.

### Third Embodiment

According to an embodiment of the present disclosure, the decoding unit 1020 may decode other control information to determine the time-frequency position of each of the multiple first DCIs.

That is, the other control information may have for example the structure shown in Table 1, and the decoding unit 1020 may successively determine the time-frequency positions of respective first DCIs according to the content of the other control information.

According to an embodiment of the present disclosure, the decoding unit 1020 may further determine modulation and coding scheme (MCS) of the first DCI and/or transmission configuration indicator (TCI) status indication of the first DCI based on the second DCI.

A process of decoding the first DCI by the decoding unit 1020 is described in detail below.

According to an embodiment of the present disclosure, the decoding unit 1020 may decode the first DCI to determine position information included in the scheduling information for the multiple data channels, so as to determine the time-frequency position of each of the multiple data channels.

### First Embodiment

According to an embodiment of the present disclosure, the position information may include a time slot where each data channel is located, a time-domain position of each data channel in a time slot, and a frequency-domain position of each data channel.

That is, the first DCI may have a structure as shown in Table 4, and the decoding unit 1020 may determine the time-frequency positions of respective data channels based on the first DCI.

According to an embodiment of the present disclosure, the decoding unit 1020 may further determine whether each of the multiple data channels is an uplink data channel or a downlink data channel based on uplink-downlink indication information in the scheduling information of the multiple data channels.

For example, the first DCI includes only such 1-bit indication information. When the bit is 0, the electronic device 1000 may determine that the multiple data channels scheduled by the first DCI are downlink data channels. When the bit is 1, the electronic device 1000 may determine that the multiple data channels scheduled by the first DCI are uplink data channels.

According to an embodiment of the present disclosure, if the first DCI includes such 1-bit indication information for each data channel, when the bit is 0, the electronic device 1000 may determine that the data channel is a downlink data channel. When the bit is 1, the electronic device 1000 may determine that the data channel is an uplink data channel.

According to an embodiment of the present disclosure, the decoding unit 1020 may further determine whether the multiple data channels scheduled by the first DCI are of the same type based on a data-channel type indication in the scheduling information for the multiple data channels. For example, when the bit is 1, the decoding unit 1020 may determine that the multiple data channels are all downlink data channels or all uplink data channels. When the bit is 0, the decoding unit 1020 may determine that a portion of the multiple data channels are downlink data channels and the other portion are uplink data channels.

Thus, the decoding unit 1020 may determine whether each data channel is an uplink data channel or a downlink data channel and a time-frequency position of each data channel based on the first DCI.

### Second Embodiment

According to an embodiment of the present disclosure, the position information may include a time slot where each data channel is located, a time-domain position of one of multiple data channels in a time slot, and a frequency-domain position of one data channel.

That is, the content in the first DCI may be as shown in Table 8.

According to an embodiment of the present disclosure, the electronic device 1000 may determine a time-frequency position of one data channel based on the first DCI. Further, the electronic device 1000 takes the time-domain position of the one data channel in a time slot as time-domain positions of the other data channels in a time slot, and takes the frequency-domain position of the one data channel as frequency-domain positions of the other data channels. Further, the electronic device 1000 may determine time-domain positions of the other data channels based on the time slots where the other data channels are located and the time-domain positions of the other data channels in a time slot, so as to determine time-frequency positions of the other data channels.

According to an embodiment of the present disclosure, the decoding unit 1020 may further determine whether each of the multiple data channels is an uplink data channel or a downlink data channel based on uplink-downlink indication information in the scheduling information for the multiple data channels.

For example, the first DCI includes only such 1-bit indication information. When the bit is 1, the electronic device 1000 may determine that the multiple data channels scheduled by the first DCI are all downlink data channels. When the bit is 0, the electronic device 1000 may determine that the multiple data channels scheduled by the first DCI are all uplink data channels.

According to an embodiment of the present disclosure, if the first DCI includes such 1-bit indication information for each data channel, when the bit is 1, the electronic device 1000 may determine that the data channel is a downlink data channel. When the bit is 0, the electronic device 1000 may determine that the data channel is an uplink data channel.

According to an embodiment of the present disclosure, the decoding unit 1020 may further determine whether the multiple data channels scheduled by the first DCI are of the same type based on data-channel type indication in the scheduling information for the multiple data channels. For example, when the bit is 1, the decoding unit 1020 may determine that the multiple data channels are all downlink data channels or all uplink data channels. When the bit is 0, the decoding unit 1020 may determine that a portion of the multiple data channels are downlink data channels and the other portion are uplink data channels.

Thus, the decoding unit 1020 determines whether each data channel is an uplink data channel or a downlink data channel and determines the time-frequency position of each data channel based on the first DCI.

According to an embodiment of the present disclosure, the decoding unit 1020 may further determine whether the multiple data channels scheduled by the first DCI are consecutive based on the first DCI. For example, in a case that the indication information included in the first DCI which indicates whether the multiple data channels are consecutive is 0, the decoding unit 1020 determines that the multiple data channels scheduled by the first DCI are inconsecutive. In a case that the indication information is 1, the decoding unit 1020 determines that multiple data channels scheduled by the first DCI are consecutive.

According to an embodiment of the present disclosure, in a case that the multiple data channels scheduled by the first DCI are consecutive, the decoding unit 1020 may determine time slots where other data channels are located based on the time slot where the first data channel is located included in the first DCI.

In addition, according to an embodiment of the present disclosure, the decoding unit 1020 may further determine, based on the first DCI, one or more of the following information for decoding the data channels: MCS of each data channel, TCI status indication of each data channel, and identification information of each data channel.

FIG. 11 is a flowchart showing signaling between a network side device and user equipment according to an embodiment of the present disclosure. The gNB in FIG. 11 may be implemented by the electronic device 100, and the UE may be implemented by the electronic device 1000. As shown in FIG. 11, in step S1101, the gNB sends second DCI to the UE through a control channel. In step S1102, the UE performs blind detection and decoding on the PDCCH to obtain the second DCI, to determine information related to decoding the first DCI, which includes but is not limited to time-frequency positions of respective first DCIs. In step S1103, the gNB sends the first DCI to the UE multiple times through the data channel. In step S1104, the UE decodes the first DCI to determine information related to decoding the data channel, which includes but is not limited to the time-frequency position and uplink/downlink for the data channel. As shown in FIG. 11, the gNB carries multiple first DCIs through the data channels, so as to schedule multiple data channels.

### 4. Method Embodiment

Next, a wireless communication method performed by the electronic device 100 as a network side device in a wireless communication system according to an embodiment of the present disclosure is described in detail.

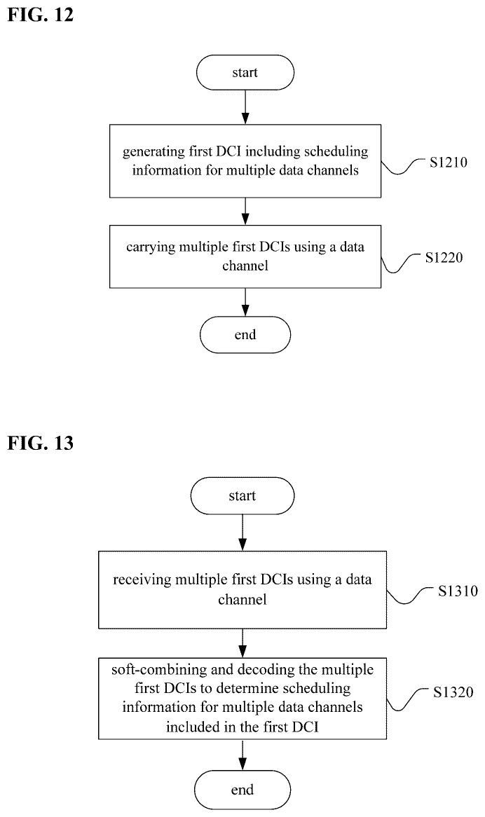

FIG. 12 is a flowchart of a wireless communication method performed by the electronic device 100 as a network side device in a wireless communication system according to an embodiment of the present disclosure.

As shown in FIG. 12, in step S1210, first DCI is generated. The first DCI includes scheduling information for multiple data channels.

Next, in step S1220, multiple first DCIs are carried using a data channel.

Preferably, the wireless communication method further includes generating second DCI. The second DCI includes information related to decoding the multiple first DCIs.

Preferably, the second DCI includes indication information of a time-frequency position of each of the multiple first DCIs.

Preferably, the second DCI includes a time-frequency position of one of the multiple first DCIs, and the wireless communication method further includes generating other control information than the first DCI and the second DCI. The other control information includes the number of the multiple first DCIs and a relationship between time-frequency positions of the multiple first DCIs.

Preferably, the second DCI includes a time-frequency position of one of the multiple first DCIs, and the wireless communication method further includes generating other control information than the first DCI and the second DCI. The other control information includes the number of the multiple first DCIs and the time-frequency position of each first DCI other than the one first DCI.

Preferably, the wireless communication method further includes generating other control information than the first DCI and the second DCI. The other control information includes the time-frequency position of each of the multiple first DCIs.

Preferably, the wireless communication method further includes carrying the second DCI using a control channel.

Preferably, the wireless communication method further includes determining the time-frequency position of each of the multiple data channels based on position information included in the scheduling information for the multiple data channels.

Preferably, the position information includes a time slot where each data channel is located, a time-domain position of each data channel in a time slot, and a frequency-domain position of each data channel.

Preferably, the position information includes a time slot where each data channel is located, a time-domain position of one of the multiple data channels in a time slot, and a frequency-domain position of the one data channel.

Preferably, the scheduling information for the multiple data channels further includes uplink-downlink indication information. The uplink-downlink indication information indicates whether each of the multiple data channels is an uplink data channel or a downlink data channel.

Preferably, each of the multiple data channels is an uplink data channel or a downlink data channel, and the multiple data channels are consecutive or inconsecutive in time domain.

According to the embodiments of the present disclosure, a subject that performs the above method may be the electronic device 100 according to the embodiments of the present disclosure, so all the previous embodiments regarding the electronic device 100 are applicable herein.

Next, a wireless communication method performed by the electronic device 1000 as user equipment in a wireless communication system according to an embodiment of the present disclosure is described in detail.

FIG. 13 is a flowchart of a wireless communication method performed by the electronic device 1000 as user equipment in a wireless communication system according to an embodiment of the present disclosure.

As shown in FIG. 13, in step S1310, multiple first DCIs are received using a data channel.

Next, in step S1320, the multiple first DCIs are soft-combined and decoded to determine scheduling information for multiple data channels included in the first DCI.

Preferably, the wireless communication method further includes performing blind detection and decoding on a control channel to determine second DCI; and determining information related to decoding the multiple first DCIs based on the second DCI.

Preferably, the information related to decoding the multiple first DCIs includes indication information of a time-frequency position of each of the multiple first DCIs.

Preferably, the information related to decoding the multiple first DCIs includes a time-frequency position of one of the multiple first DCIs, and the wireless communication method further includes determining the number of the multiple first DCIs and a relationship between time-frequency positions of the multiple first DCIs based on other control information than first DCI and the second DCI; and determining a time-frequency position of other first DCI based on the time-frequency position of the one first DCI, the number of the multiple first DCIs, and the relationship between the time-frequency positions of the multiple first DCIs.

Preferably, the information related to decoding the multiple first DCIs includes a time-frequency position of one of the multiple first DCIs, and the wireless communication method further includes determining the number of the multiple first DCIs and the time-frequency position of each first DCI other than the one first DCI based on other control information than the first DCI and the second DCI.

Preferably, the wireless communication method further includes determining the time-frequency position of each of the multiple first DCIs based on other control information than the first DCI and the second DCI.

Preferably, the wireless communication method further includes determining the time-frequency position of each of the multiple data channels based on position information included in the scheduling information for the multiple data channels.

Preferably, the position information includes a time slot where each data channel is located, a time-domain position of each data channel in a time slot, and a frequency-domain position of each data channel.

Preferably, the position information includes a time slot in which each data channel is located, a time-domain position of one of the multiple data channels in a time slot, and a frequency-domain position of the one data channel. The wireless communication method further includes determining the time-domain position of the one data channel in a time slot as time-domain positions of the other data channels in a time slot, and determining the frequency-domain position of the one data channel as frequency-domain positions of the other data channels.

Preferably, the wireless communication method further includes determining whether each of the multiple data channels is an uplink data channel or a downlink data channel based on uplink-downlink indication information included in the scheduling information for the multiple data channels.

Preferably, each of the multiple data channels is an uplink data channel or a downlink data channel, and the multiple data channels are consecutive or inconsecutive in time domain.

According to the embodiments of the present disclosure, a subject that performs the above method may be the electronic device 1000 according to the embodiments of the present disclosure, so all the previous embodiments regarding the electronic device 1000 are applicable herein.

### 5. Application Example

The technology of the present disclosure is applicable to various products.

For example, the network side device may be implemented as any type of base station device, such as a macro eNB and a small eNB, and may be implemented as any type of gNB (a base station in a 5G system). The small eNB may be an eNB covering a cell smaller than a macro cell, such as a pico eNB, a micro eNB, or a home (femto) eNB. Alternatively, the base station may be implemented as any other type of base station, such as a NodeB and a base transceiver station (BTS). The base station may include a body (which is also referred to as a base station device) configured to control wireless communication and one or more remote radio heads (RRHs) that are arranged in a different place from the body.

The user equipment may be implemented as a mobile terminal (such as a smartphone, a tablet personal computer (PC), a notebook PC, a portable game terminal, a portable/dongle-type mobile router, and a digital camera), or an in-vehicle terminal (such as a car navigation device). The user equipment may also be implemented as a terminal that performs machine-to-machine (M2M) communication (which is also referred to as machine type communication (MTC) terminal). In addition, the user equipment may be a wireless communication module (such as an integrated circuit module including a single wafer) installed on each of the user equipment described above.

### Application Examples of a Base Station

### First Application Example

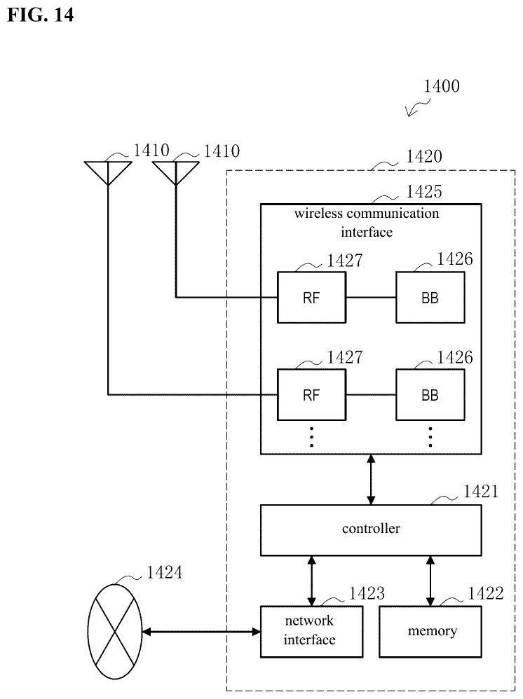

FIG. 14 is a block diagram showing a first example of a schematic configuration of an eNB to which the technology of the present disclosure may be applied. The eNB 1400 includes a single or multiple antennas 1410 and a base station device 1420. The base station device 1420 and each of the antennas 1410 may be connected to each other via an RF cable.

Each of the antennas 1410 includes a single or multiple antenna elements (such as multiple antenna elements included in a multiple-input multiple-output (MIMO) antenna), and is used for the base station device 1420 to transmit and receive wireless signals. The eNB 1400 may include multiple antennas 1410, as shown in FIG. 14. For example, the multiple antennas 1410 may be compatible with multiple frequency bands used by the eNB 1400. Although FIG. 14 shows an example in which the eNB 1400 includes multiple antennas 1410, the eNB 1400 may include a single antenna 1410.

The base station device 1420 includes a controller 1421, a memory 1422, a network interface 1423, and a wireless communication interface 1425.

The controller 1421 may be, for example, a CPU or a DSP, and operates various functions of a higher layer of the base station device 1420. For example, the controller 1421 generates a data packet based on data in a signal processed by the wireless communication interface 1425, and transfers the generated packet via the network interface 1423. The controller 1421 may bundle data from multiple baseband processors to generate a bundled packet, and transfer the generated bundled packet. The controller 1421 may have logical functions of performing control such as radio resource control, radio bearer control, mobility management, admission control, and scheduling. The control may be performed in conjunction with an adjacent eNB or a core network node. The memory 1422 includes an RAM and an ROM, and stores a program executed by the controller 1421, and various types of control data (such as a terminal list, transmission power data, and scheduling data).

The network interface 1423 is a communication interface for connecting the base station device 1420 to a core network 1424. The controller 1421 may communicate with a core network node or another eNB via the network interface 1423. In this case, the eNB 1400, and the core network node or the other eNB may be connected to each other through a logical interface (such as an Si interface and an X2 interface). The network interface 1423 may also be a wired communication interface or a wireless communication interface for a wireless backhaul line. In a case that the network interface 1423 is a wireless communication interface, the network interface 1423 may use a higher frequency band for wireless communication than a frequency band used by the wireless communication interface 1425.

The wireless communication interface 1425 supports any cellular communication scheme (such as Long Term Evolution (LTE) and LTE-Advanced), and provides wireless connection to a terminal positioned in a cell of the eNB 1400 via the antenna 1410. The wireless communication interface 1425 may typically include, for example, a baseband (BB) processor 1426 and a RF circuit 1427. The BB processor 1426 may perform, for example, encoding/decoding, modulating/demodulating and multiplexing/de-multiplexing, and perform various types of signal processes of layers (for example, L1, media access control (MAC), radio link control (RLC) and packet data convergence protocol (PDCP)). Instead of the controller 1421, the BB processor 1426 may have a part or all of the above logical functions. The BB processor 1426 may be a memory storing a communication control program, or a module including a processor and a related circuit configured to execute the program. Updating the program may change the functions of the BB processor 1426. The module may be a card or a blade inserted into a slot of the base station device 1420. Alternatively, the module may also be a chip mounted on the card or the blade. In addition, the RF circuit 1427 may include, for example, a frequency mixer, a filter and an amplifier, and transmit and receive wireless signals via the antenna 1410.

As shown in FIG. 14, the wireless communication interface 1425 may include multiple BB processors 1426. For example, the multiple BB processors 1426 may be compatible with multiple frequency bands used by the eNB 1400. As shown in FIG. 14, the wireless communication interface 1425 may include multiple RF circuits 1427. For example, the multiple RF circuits 1427 may be compatible with multiple antenna elements. Although FIG. 14 shows an example in which the wireless communication interface 1425 includes multiple BB processors 1426 and multiple RF circuits 1427, the wireless communication interface 1425 may include a single BB processor 1426 or a single RF circuit 1427.

### Second Application Example

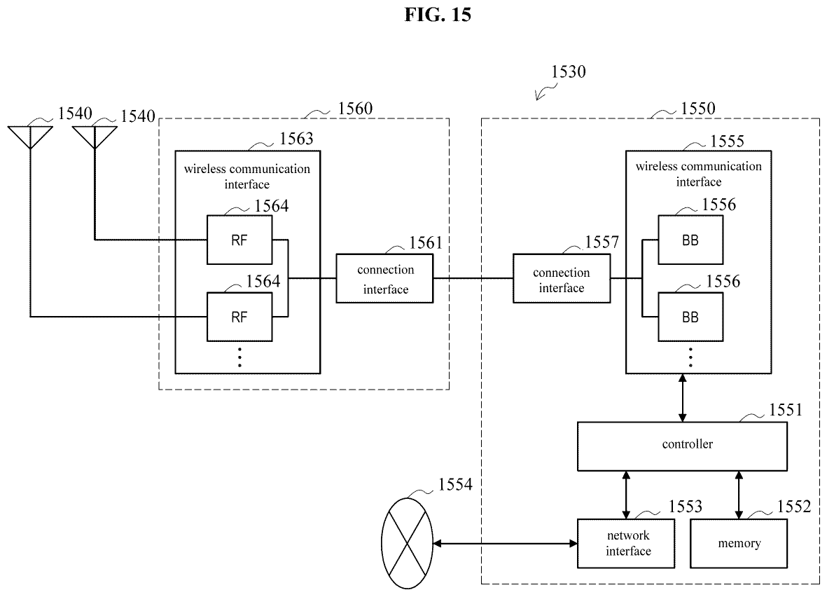

FIG. 15 is a block diagram showing a second example of a schematic configuration of an eNB to which the technology of the present disclosure may be applied. The eNB 1530 includes a single or multiple antennas 1540, a base station device 1550 and an RRH 1560. The RRH 1560 and each antenna 1540 may be connected to each other via an RF cable. The base station device 1550 and the RRH 1560 may be connected to each other via a high-speed line such as an optical fiber cable.

Each of the antennas 1540 includes a single or multiple antenna elements (such as multiple antenna elements included in an MIMO antenna), and is used for the RRH 1560 to transmit and receive wireless signals. As shown in FIG. 15, the eNB 1530 may include multiple antennas 1540. For example, the multiple antennas 1540 may be compatible with multiple frequency bands used by the eNB 1530. Although FIG. 15 shows an example in which the eNB 1530 includes multiple antennas 1540, the eNB 1530 may include a single antenna 1540.

The base station device 1550 includes a controller 1551, a memory 1552, a network interface 1553, a wireless communication interface 1555, and a connection interface 1557. The controller 1551, the memory 1552, and the network interface 1553 are the same as the controller 1421, the memory 1422, and the network interface 1423 described with reference to FIG. 14. The network interface 1553 is a communication interface for connecting the base station device 1550 to a core network 1554.

The wireless communication interface 1555 supports any cellular communication scheme (such as LTE and LTE-advanced), and provides wireless communication with a terminal located in a sector corresponding to the RRH 1560 via the RRH 1560 and the antenna 1540. The wireless communication interface 1555 may typically include, for example, a BB processor 1556. The BB processor 1556 is the same as the BB processor 1426 described with reference to FIG. 14, except that the BB processor 1556 is connected to a RF circuit 1564 of the RRH 1560 via the connection interface 1557. As shown in FIG. 15, the wireless communication interface 1555 may include multiple BB processors 1556. For example, the multiple BB processors 1556 may be compatible with multiple frequency bands used by the eNB 1530. Although FIG. 15 shows an example in which the wireless communication interface 1555 includes multiple BB processors 1556, the wireless communication interface 1555 may include a single BB processor 1556.

The connection interface 1557 is an interface for connecting the base station device 1550 (the wireless communication interface 1555) to the RRH 1560. The connection interface 1557 may also be a communication module for communication in the above high-speed line that connects the base station device 1550 (the wireless communication interface 1555) to the RRH 1560.

The RRH 1560 includes a connection interface 1561 and a wireless communication interface 1563.

The connection interface 1561 is an interface for connecting the RRH 1560 (the wireless communication interface 1563) to the base station device 1550. The connection interface 1561 may also be a communication module for communication in the above high-speed line.

The wireless communication interface 1563 transmits and receives wireless signals via the antenna 1540. The wireless communication interface 1563 may typically include, for example, the RF circuit 1564. The RF circuit 1564 may include, for example, a frequency mixer, a filter and an amplifier, and transmit and receive wireless signals via the antenna 1540. The wireless communication interface 1563 may include multiple RF circuits 1564, as shown in FIG. 15. For example, the multiple RF circuits 1564 may support multiple antenna elements. Although FIG. 15 shows an example in which the wireless communication interface 1563 includes multiple RF circuits 1564, the wireless communication interface 1563 may include a single RF circuit 1564.

In the eNB 1400 shown in FIG. 14 and the eNB 1530 shown in FIG. 15, the first generation unit 110, the encoding unit 120, the second generation unit 140 and the third generation unit 150 described in connection with FIG. 1 may be implemented by the controller 1421 and/or the controller 1551. At least a part of the functions may be implemented by the controller 1421 and the controller 1551. For example, the controller 1421 and/or the controller 1551 may generate the first DCI, generate the second DCI, generate other control information and encode the generated information by executing instructions stored in a corresponding memory.

### Application Examples of a Terminal Device

### First Application Example

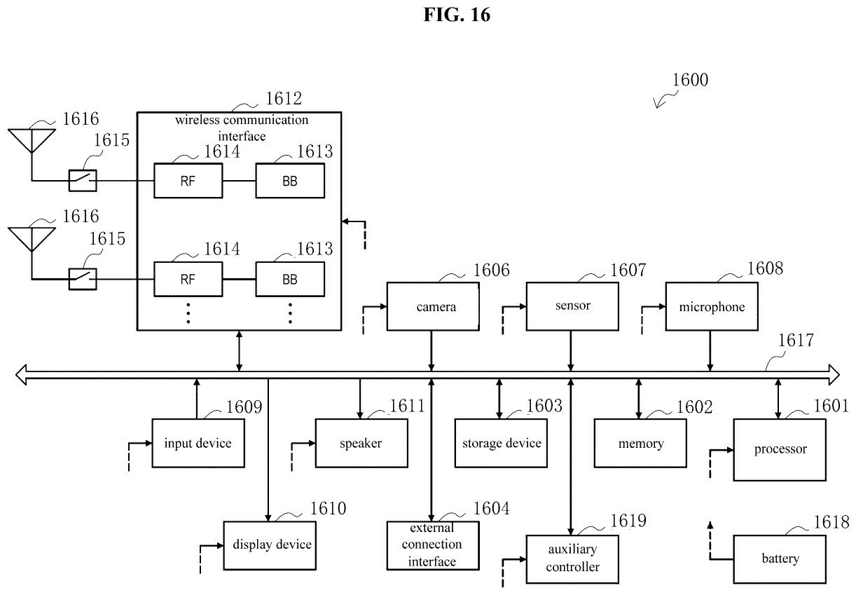

FIG. 16 is a block diagram showing an example of a schematic configuration of a smartphone 1600 to which the technology of the present disclosure may be applied. The smartphone 1600 includes a processor 1601, a memory 1602, a storage device 1603, an external connection interface 1604, a camera 1606, a sensor 1607, a microphone 1608, an input device 1609, a display device 1610, a speaker 1611, a wireless communication interface 1612, one or more antenna switches 1615, one or more antennas 1616, a bus 1617, a battery 1618 and an auxiliary controller 1619.

The processor 1601 may be, for example, a CPU or a system on chip (SoC), and control functions of an application layer and another layer of the smartphone 1600. The memory 1602 includes an RAM and an ROM, and stores a program that is executed by the processor 1601, and data. The storage device 1603 may include a storage medium such as a semiconductor memory and a hard disk. The external connection interface 1604 is an interface for connecting an external device (such as a memory card and a universal serial bus (USB) device) to the smartphone 1600.

The camera 1606 includes an image sensor (such as a charge coupled device (CCD) and a complementary metal oxide semiconductor (CMOS)) and generates a captured image. The sensor 1607 may include a group of sensors, such as a measurement sensor, a gyroscope sensor, a geomagnetic sensor and an acceleration sensor. The microphone 1608 converts sounds that are inputted to the smartphone 1600 into audio signals. The input device 1609 includes, for example, a touch sensor configured to detect touch on a screen of the display device 1610, a keypad, a keyboard, a button, or a switch, and receives an operation or information inputted from a user. The display device 1610 includes a screen (such as a liquid crystal display (LCD) and an organic light-emitting diode (OLED) display), and displays an output image of the smartphone 1600. The speaker 1611 converts audio signals that are outputted from the smartphone 1600 to sounds.

The wireless communication interface 1612 supports any cellular communication scheme (such as LTE and LTE-Advanced), and performs wireless communications. The wireless communication interface 1612 may typically include, for example, a BB processor 1613 and a RF circuit 1614. The BB processor 1613 may perform, for example, encoding/decoding, modulating/demodulating and multiplexing/de-multiplexing, and perform various types of signal processing for wireless communications. Meanwhile, the RF circuit 1614 may include, for example, a frequency mixer, a filter and an amplifier, and transmit and receive wireless signals via the antenna 1616. The wireless communication interface 1612 may be a chip module on which the BB processor 1613 and the RF circuit 1614 are integrated. As shown in FIG. 16, the wireless communication interface 1612 may include multiple BB processors 1613 and multiple RF circuits 1614. Although FIG. 16 shows an example in which the wireless communication interface 1612 includes multiple BB processors 1613 and multiple RF circuits 1614, the wireless communication interface 1612 may include a single BB processor 1613 or a single RF circuit 1614.

Furthermore, in addition to the cellular communication scheme, the wireless communication interface 1612 may support another type of wireless communication scheme such as a short-distance wireless communication scheme, a near field communication scheme, and a wireless local area network (LAN) scheme. In this case, the wireless communication interface 1612 may include a BB processor 1613 and a RF circuit 1614 for each wireless communication scheme.

Each of the antenna switches 1615 switches a connection destination of the antenna 1616 among multiple circuits (such as circuits for different wireless communication schemes) included in the wireless communication interface 1612.

Each of the antennas 1616 includes a single or multiple antenna elements (such as multiple antenna elements included in an MIMO antenna), and is used for the wireless communication interface 1612 to transmit and receive wireless signals. The smartphone 1600 may include multiple antennas 1616, as shown in FIG. 16. Although FIG. 16 shows an example in which the smartphone 1600 includes multiple antennas 1616, the smartphone 1600 may include a single antenna 1616.

Furthermore, the smartphone 1600 may include an antenna 1616 for each wireless communication scheme. In this case, the antenna switch 1615 may be omitted from the configuration of the smartphone 1600.

The processor 1601, the memory 1602, the storage device 1603, the external connection interface 1604, the camera 1606, the sensor 1607, the microphone 1608, the input device 1609, the display device 1610, the speaker 1611, the wireless communication interface 1612 and the auxiliary controller 1619 are connected to each other via the bus 1617. The battery 1618 supplies power to blocks in the smartphone 1600 shown in FIG. 16 via a feeder line which is indicated partially as a dashed line in FIG. 16. The auxiliary controller 1619 operates a minimum necessary function of the smartphone 1600 in a sleeping mode, for example.

In the smartphone 1600 shown in FIG. 16, the decoding unit 1020 described in connection with FIG. 10 may be implemented by the processor 1601 or the auxiliary controller 1619. At least a part of the functions may be implemented by the processor 1601 or the auxiliary controller 1619. For example, the processor 1601 or the auxiliary controller 1619 may decode the received information by executing instructions stored in the memory 1602 or the storage device 1603.

### Second Application Example

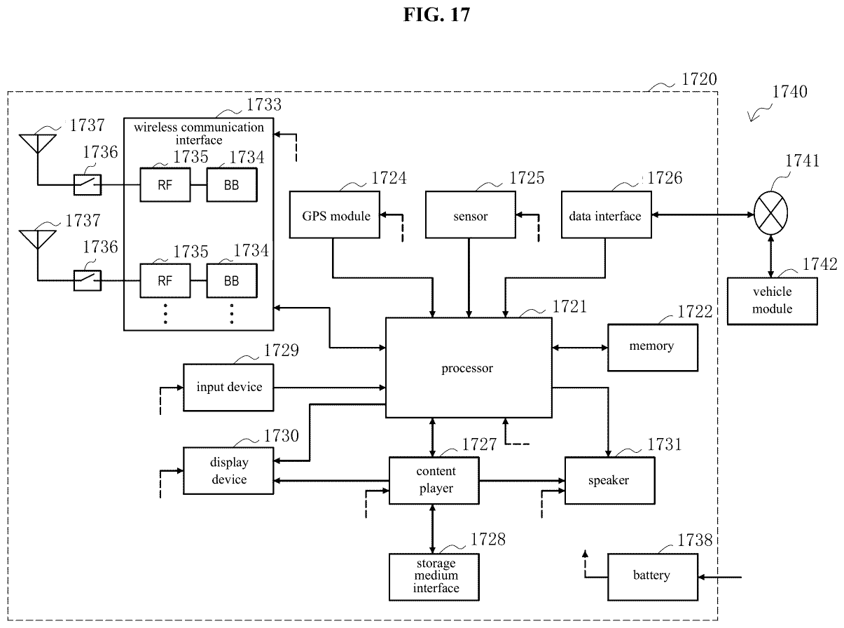

FIG. 17 is a block diagram showing an example of a schematic configuration of a car navigation device 1720 to which the technology of the present disclosure may be applied. The car navigation device 1720 includes a processor 1721, a memory 1722, a global positioning system (GPS) module 1724, a sensor 1725, a data interface 1726, a content player 1727, a storage medium interface 1728, an input device 1729, a display device 1730, a speaker 1731, a wireless communication interface 1533, one or more antenna switches 1736, one or more antennas 1737 and a battery 1738.

The processor 1721 may be, for example, a CPU or an SoC, and control a navigation function and another function of the car navigation device 1720. The memory 1722 includes an RAM and an ROM, and stores a program that is executed by the processor 1721, and data.

The GPS module 1724 measures a position (such as latitude, longitude and altitude) of the car navigation device 1720 based on a GPS signal received from a GPS satellite. The sensor 1725 may include a group of sensors such as a gyroscope sensor, a geomagnetic sensor, and an air pressure sensor. The data interface 1726 is connected to, for example, an in-vehicle network 1741 via a terminal not shown, and acquires data generated by the vehicle (such as vehicle speed data).

The content player 1727 reproduces content stored in a storage medium (such as a CD and a DVD) inserted into the storage medium interface 1728. The input device 1729 includes, for example, a touch sensor configured to detect touch on a screen of the display device 1730, a button, or a switch, and receives an operation or information inputted from a user. The display device 1730 includes a screen such as an LCD or an OLED display, and displays an image of the navigation function or content that is reproduced. The speaker 1731 outputs sound of the navigation function or the content that is reproduced.

The wireless communication interface 1733 supports any cellular communication scheme (such as LTE and LTE-Advanced), and performs wireless communications. The wireless communication interface 1733 may typically include, for example, a BB processor 1734 and a RF circuit 1735. The BB processor 1734 may perform, for example, encoding/decoding, modulating/demodulating and multiplexing/de-multiplexing, and perform various types of signal processing for wireless communications. Meanwhile, the RF circuit 1735 may include, for example, a frequency mixer, a filter and an amplifier, and transmit and receive wireless signals via the antenna 1737. The wireless communication interface 1733 may also be a chip module on which the BB processor 1734 and the RF circuit 1735 are integrated. As shown in FIG. 17, the wireless communication interface 1733 may include multiple BB processors 1734 and multiple RF circuits 1735. Although FIG. 17 shows an example in which the wireless communication interface 1733 includes multiple BB processors 1734 and multiple RF circuits 1735, the wireless communication interface 1733 may include a single BB processor 1734 or a single RF circuit 1735.

Furthermore, in addition to the cellular communication scheme, the wireless communication interface 1733 may support another type of wireless communication scheme such as a short-distance wireless communication scheme, a near field communication scheme, and a wireless LAN scheme. In this case, the wireless communication interface 1733 may include a BB processor 1734 and a RF circuit 1735 for each type of wireless communication scheme.

Each of the antenna switches 1736 switches a connection destination of the antenna 1737 among multiple circuits (such as circuits for different wireless communication schemes) included in the wireless communication interface 1733.

Each of the antennas 1737 includes a single or multiple antenna elements (such as multiple antenna elements included in an MIMO antenna), and is used for the wireless communication interface 1733 to transmit and receive wireless signals. The car navigation device 1720 may include multiple antennas 1737, as shown in FIG. 17. Although FIG. 17 shows an example in which the car navigation device 1720 includes multiple antennas 1737, the car navigation device 1720 may include a single antenna 1737.

In addition, the car navigation device 1720 may include an antenna 1737 for each type of wireless communication scheme. In this case, the antenna switch 1736 may be omitted from the configuration of the car navigation device 1720.

The battery 1738 supplies power to blocks in the car navigation device 1720 shown in FIG. 17 via a feeder line which is indicated partially as a dashed line in FIG. 17. The battery 1738 accumulates power supplied from the vehicle.

In the car navigation device 1720 shown in FIG. 17, the decoding unit 1020 described in connection with FIG. 10 described in connection with FIG. 10 may be implemented by the processor 1721. At least a part of the functions may be implemented by the processor 1721. For example, the processor 1721 may decode the received information by executing instructions stored in the memory 1722.

The technology of the present disclosure may also be implemented as an in-vehicle system (or a vehicle) 1740 including one or more blocks of the car navigation device 1720, the in-vehicle network 1741 and a vehicle module 1742. The vehicle module 1742 generates vehicle data (such as vehicle speed, engine speed, and fault information), and outputs the generated data to the in-vehicle network 1741.

Preferred embodiments of the present disclosure have been described above with reference to the drawings. However, the present disclosure is not limited to the above examples. Those skilled in the art may make various changes and modifications within the scope of the appended claims, and it should be understood that such changes and modifications naturally fall within the technical scope of the present disclosure.

For example, a unit shown by a dotted line box in the functional block diagram in the drawings indicates that the functional unit is optional in the corresponding device, and the optional functional units may be combined appropriately to achieve desired functions.

For example, multiple functions implemented by one unit in the above embodiments may be implemented by separate devices. Alternatively, multiple functions implemented by respective units in the above embodiments may be implemented by separate devices, respectively. In addition, one of the above functions may be implemented by multiple units. Such configurations are naturally included in the technical scope of the present disclosure.

In the specification, steps described in the flowchart include not only the processes performed chronologically as the described sequence, but also the processes performed in parallel or individually rather than chronologically. Furthermore, the steps performed chronologically may be performed in another sequence appropriately.

Embodiments of the present disclosure are described above in detail in conjunction with the drawings. However, it should be understood that the embodiments described above are intended to illustrate the present disclosure rather than limit the present disclosure. Those skilled in the art may make various modifications and alternations to the above embodiments without departing from the spirit and scope of the present disclosure. Therefore, the scope of the present disclosure is defined by the appended claims and equivalents thereof.

1. An electronic device, comprising processing circuitry configured to:
generate first downlink control information (DCI) comprising scheduling information for a plurality of data channels; and
carry a plurality of the first DCIs using a data channel.

2. The electronic device according to claim 1, wherein the processing circuitry is further configured to:
generate second DCI comprising information related to decoding the plurality of first DCIs;
carry the second DCI using a control channel; and
generate other control information than the first DCI and the second DCI, the other control information comprising a time-frequency position of each of the plurality of first DCIs.

3. The electronic device according to claim 2, wherein the second DCI comprises indication information of a time-frequency position of each of the plurality of first DCIs.

4. The electronic device according to claim 2, wherein the second DCI comprises a time-frequency position of one of the plurality of first DCIs, and
wherein the processing circuitry is further configured to generate other control information than the first DCI and the second DCI, the other control information comprising the number of the plurality of first DCIs and a relationship between the time-frequency positions of the plurality of first DCIs.

5. The electronic device according to claim 2, wherein the second DCI comprises a time-frequency position of one of the plurality of first DCIs, and
wherein the processing circuitry is further configured to generate other control information than the first DCI and the second DCI, the other control information comprising the number of the plurality of first DCIs and a time-frequency position of each first DCI other than the one first DCI.

6.-7. (canceled)

8. The electronic device according to claim 1, wherein the scheduling information for the plurality of data channels comprises position information related to a time-frequency position of each of the plurality of data channels.

9. The electronic device according to claim 8, wherein the position information comprises a time slot where each data channel is located, a time-domain position of each data channel in a time slot, and a frequency-domain position of each data channel.

10. The electronic device according to claim 8, wherein the position information comprises a time slot where each data channel is located, a time-domain position of one of the plurality of data channels in a time slot, and a frequency-domain position of the one data channel.

11. The electronic device according to claim 1, wherein the scheduling information of the plurality of data channels further comprises uplink-downlink indication information that indicates whether each of the plurality of data channels is an uplink data channel or a downlink data channel.

12. The electronic device according to claim 1, wherein each of the plurality of data channels is an uplink data channel or a downlink data channel, and the plurality of data channels are consecutive or inconsecutive in time domain.

13. An electronic device, comprising processing circuitry configured to:
receive a plurality of first downlink control information (DCIs) using a data channel; and
soft-combine and decode the plurality of first DCIs to determine scheduling information for a plurality of data channels included in the first DCI.

14. (canceled)

15. The electronic device according to claim 13, wherein the processing circuitry is further configured to:
perform blind detection and decoding on a control channel to determine second DCI and;
determine information related to decoding the plurality of first DCIs based on the second DCI;
wherein the information related to decoding the plurality of first DCIs comprises indication information of a time-frequency position of each of the plurality of first DCIs.

16. The electronic device according to claim 13, wherein the processing circuitry is further configured to:
perform blind detection and decoding on a control channel to determine second DCI; and
determine information related to decoding the plurality of first DCIs based on the second DCI,
wherein the information related to decoding the plurality of first DCIs comprises a time-frequency position of one of the plurality of first DCIs, and
wherein the processing circuitry is further configured to:
determine the number of the plurality of first DCIs and a relationship between time-frequency positions of the plurality of first DCIs based on other control information than the first DCI and the second DCI; and
determine a time-frequency position of other first DCI based on the time-frequency position of the one first DCI, the number of the plurality of first DCIs, and the relationship between the time-frequency positions of the plurality of first DCIs.

17. The electronic device according to claim 13, wherein the processing circuitry is further configured to:
perform blind detection and decoding on a control channel to determine second DCI; and
determine information related to decoding the plurality of first DCIs based on the second DCI,
wherein the information related to decoding the plurality of first DCIs comprises a time-frequency position of one of the plurality of first DCIs, and
wherein the processing circuitry is further configured to:
determine the number of the plurality of first DCIs and a time-frequency position of each first DCI other than the one first DCI, based on other control information than the first DCI and the second DCI.

18. The electronic device according to claim 13, wherein the processing circuitry is further configured to:
determine a time-frequency position of each of the plurality of first DCIs based on other control information than the first DCI and the second DCI.

19. The electronic device according to claim 13, wherein the processing circuitry is further configured to:
determine a time-frequency position of each of the plurality of data channels based on position information included in the scheduling information for the plurality of data channels.

20. The electronic device according to claim 19, wherein the position information comprises a time slot where each data channel is located, a time-domain position of each data channel in a time slot, and a frequency-domain position of each data channel.

21. The electronic device according to claim 19, wherein the position information comprises a time slot where each data channel is located, a time-domain position of one of the plurality of data channels in a time slot, and a frequency-domain position of the one data channel, and
wherein the processing circuitry is further configured to:
determine the time-domain position of the one data channel in a time slot as time-domain positions of the other data channels in a time slot, and determine the frequency-domain position of the one data channel as frequency-domain positions of the other data channels.

22. The electronic device according to claim 13, wherein the processing circuitry is further configured to:
determine whether each of the plurality of data channels is an uplink data channel or a downlink data channel based on uplink-downlink indication information included in the scheduling information for the plurality of data channels.

23. The electronic device according to claim 13, wherein each of the plurality of data channels is an uplink data channel or a downlink data channel, and the plurality of data channels are consecutive or inconsecutive in time domain.

24.-47. (canceled)
